(19) United States
(12) Patent Application Publication
(10) Pub. No.: US 2025/0198664 A1
(43) Pub. Date: Jun. 19, 2025

(54) Cooling system, compressor system and solar tracking device

(71) Applicants: Sara Benlafqih, Paris (FR); Boutaina Mounir, Paris (FR); Carl Josue Tali Atoundou, Paris (FR)

(72) Inventors: Sara Benlafqih, Paris (FR); Boutaina Mounir, Paris (FR); Carl Josue Tali Atoundou, Paris (FR)

(21) Appl. No.: 18/843,303

(22) PCT Filed: Mar. 1, 2023
(86) PCT No.: PCT/EP2023/055193

§ 371 Date: Sep. 2, 2024

(30) Foreign Application Priority Data
Mar. 1, 2022 (EP) 22159443.5

(51) Int. Cl. F25B 9/14; F24S 23/30; F24S 50/20; F25B 27/00; H02S 20/32

(52) U.S. Cl. CPC F25B 9/14; F24S 50/20; F25B 27/002; F24S 23/31; H02S 20/32

(57) ABSTRACT

The invention relates to a cooling system including a cooling chamber, a rotary compressor for pressurising a refrigerant, a condenser, an expander configured to expand the refrigerant, and at least one evaporator operatively connected to the cooling chamber to absorb heat from the cooling chamber. The cooling system further includes a Stirling motor configured to rotatably drive the rotary compressor. The Stirling motor includes an expansion space in which at least one working medium is expandable and a first piston which is movably arranged in the expansion space. The Stirling motor is configured to cooperate with at least one heat source to expand the working medium and drive the first piston to rotatably drive the driveshaft. The invention further includes a solar energy capturing device and a solar tracking device.

### CROSS-REFERENCE TO RELATED APPLICATION(S)

This application is a 371 National Stage Application of International Application No. PCT/EP2023/055193, filed on 1 Mar. 2023, which published as WO 2023/166064 A1 on 7 Sep. 2023, which claims priority to European Patent Application No. 22159443.5, filed on 1 Mar. 2022, the contents of which are hereby incorporated by reference in their entireties.

### TECHNICAL FIELD

The use of powered appliances is indispensable in many areas of life. Various powered appliances are available for a number of different purposes, such as in assisting daily tasks, and for providing various functions and/or fulfilling various tasks.

### BACKGROUND

For instance, providing cooling to an environment by means of a refrigeration device is vital for storing and preserving perishable items, such as food times, e.g., meat or dairy products, and/or pharmaceutical products, in particular in warmer environments. A lack of cooling capabilities may result in a reduced lifetime of perishable items and/or poor hygiene and/or poor health due to spoiling of the items.

In most cases, the respective appliances, in particular cooling devices, are powered electrically, e.g., via a connection to an electrical power grid, e.g., via a household electricity connection, and/or via one or more batteries.

### SUMMARY

However, access to an electrical power grid is not always available, e.g., due to being in a remote location. Moreover, in many countries, a relatively large proportion of the respective population does not have access, or at least not regular and/or reliable access, to a source of electricity, such as an electrical power grid. This leads to various problems. One of these problems is that features in rural areas of economically poor and non-industrialized countries tend to lose a significant portion of their harvest due to lack of cooling capabilities, or are forced to sell their products at relatively low prices shortly after harvesting them.

In particular, food waste, such as spoiled food which is discarded, may have a negative effect on climate change. In fact, food waste may emit gases, such as greenhouse gases, which may lead to an increase in the earth's temperature. In turn, an increase in the earth's temperature may lead to higher levels of food spoiling. Thus, a vicious circle between increasing ambient temperatures and an increasing risk of food spoiling is formed.

Although cooling technologies can aid in increasing the lifetime of perishable items, which may reduce the degree of perishing of food items, cooling technologies may also contribute to climate change, e.g., through the emission of harmful gases, such as greenhouse gases, during manufacturing, operation and/or disposal of the respective cooling devices.

Hence, even if access to a power source, such as an electrical power grid, is available, it may be generally desirable to provide sustainable energy and/or renewable energy via the power source for powering the respective appliances.

The alternative use of batteries for powering the respective appliance is also associated with a number of disadvantages, in particular several disadvantages. For instance, batteries generally only provide a limited amount of energy to the appliance. Hence, the batteries must by replaced and/or recharged, the latter of which again generally demands access to an electrical power source for recharging purposes. Moreover, for the purpose of providing power to energy-intensive appliances, the size and/or number of the batteries must generally be increased in order to meet the demand for the increased power, which may lead to bulky and relatively heavy battery packs. Moreover, the production and/or maintenance and/or disposal of batteries is often costly and/or may have a negative impact on the environment.

The known prior art has suggested devices which reduce the dependency on electricity for powering appliances, in particular cooling appliances. For instance, U.S. Pat. No. 6,701,721 B1 discloses a heating and cooling device comprising a free piston Stirling engine which drives the compressor of a vapor compression heat pump. A free piston of the Stirling engine is integrally formed with a piston of the compressor such that power from the free piston is directly transferred to the compressor piston. DE 102 43 178 A1 discloses an air conditioning circuit for a motor vehicle which uses thermal energy to be converted into mechanical energy to supply the air conditioning. At least one energy converter or air conditioner can use a Stirling cycle engine. EP 1 772 687 A2 discloses an air-conditioner which has a mirror arrangement which directly or indirectly supplies the solar radiation in a cooling circuit. U.S. Pat. No. 4,309,877 A discloses an internal or external combustion engine for driving an electrical generator.

However, based on the prior art, there remains a need to improve cooling appliances which have a reduced dependency on electricity for powering the appliances.

Moreover, there remains a need to improve a means for driving cooling appliances which have a reduced dependency on electricity to power the appliances.

It is therefore an object of the present invention to provide an improved cooling system and/or an improved driving means for powering the cooling system.

In particular, it is an object of the present invention to provide an improved cooling system for remote areas in economically poor and non-industrialized countries, such as rural areas.

It is a further object to provide an improved cooling system for agricultural products and/or for products, preferably perishable products, which may be consumed by humans and/or animals, such as pharmaceuticals, dairy products and/or meat products.

This object is achieved by a cooling system defined by the features of claim 1.

Variations and further developments are defined by the features of the dependent claims.

The cooling system includes a refrigeration arrangement which includes at least one cooling chamber configured to receive one or more objects to be cooled. The cooling chamber may be at least partially, preferably substantially completely, enclosed in a housing. The housing may include one or more wall elements, a ceiling element and/or a floor element to delimit the cooling chamber. The housing may include one or more access elements, such as at least one door element, configured to provide external access to the cooling chamber. The housing may be provided with one or more insulation elements configured to reduce a degree of heat exchange between the cooling chamber and an external environment.

Alternatively, or additionally, the cooling system described herein may be configured to provide cooling to any space in general, referred to as a cooling space in the following, such as a room of a building or a separate compartment, such as a cooling box. For this purpose, the cooling system may be configured to absorb heat from the cooling space, for instance, by means of an evaporator of the refrigeration arrangement, the evaporator being operatively connectable to the cooling space to absorb heat from the cooling space to the refrigerant.

The cooling system may include one or more temperature sensors arranged and configured to sense one or more temperatures within the cooling chamber and/or the cooling space. The cooling system may include at least one control unit configured to receive one or more signals relating to the sensed temperature(s) and provide one or more control signals for controlling and/or adjusting the temperature(s) within the cooling chamber and/or the cooling space, e.g., in a closed-loop control.

The refrigeration arrangement may further include at least one rotary compressor for pressurising at least one refrigerant. A rotary compressor may be understood as a compressor which is rotatably driven, such as by means of one or more rotating driveshafts, in order to pressurize at least one medium, i.e., the refrigerant in the present case. For instance, the rotary compressor may be configured as a scroll compressor, a screw-type compressor, a vane-type compressor, a lobe-type (roots-style) compressor or a piston compressor having a rotating crankshaft.

The rotary compressor may be configured to provide different pressure ratios, wherein a pressure ratio is to be understood as a ratio of a pressure of the refrigerant at a location upstream from an inlet of the refrigerant into the rotary compressor to a pressure of the refrigerant at a location downstream from an outlet of the refrigerant out of the rotary compressor. The pressure ratio of the rotary compressor may be variable and/or adjustable, e.g., in steps or stepless. For instance, the pressure ratio may be variable and/or adjustable by means of user input, such as via a user interface which may receive one or more input commands by a user. The pressure ratio may be automatically variable, i.e., without user intervention, e.g., based on one or more operating conditions of the cooling system which may trigger an adjustment of the pressure ratio. Alternatively, or additionally, the rotary compressor may be configured to be operated at different rotational speeds. The rotational speed of the rotary compressor may be variable and/or adjustable, e.g., in steps or stepless, automatically and/or manually, as detailed above with respect to an adjustability and/or variability of the pressure ratio.

The rotary compressor may be configured to be operated with different refrigerants.

Preferably, the rotary compressor is configured to be operated with one or more natural refrigerants. Natural refrigerants may have a lower negative impact on the environment, such as by having lower emissions, e.g., lower CO₂ emissions and/or a lower emission of one or more further environmentally harmful gases, and/or may have lower negative health effects, e.g., than synthetic refrigerants. Many countries and/or regions and/or cities have implemented restrictions on the use of substances, such as refrigerants, based on environmental and/or health related aspects, such as by prohibiting the use of certain substances, e.g., refrigerants, due to their relatively high negative impact on the environment and/or on humans' health. Thus, by configuring the rotary compressor to be operable with natural refrigerants, which may be relatively environmentally friendly and/or health-friendly, e.g., compared with synthetic refrigerants, the rotary compressor described herein may be conform with all, or at least most, countries' and/or regions' and/or cities' laws and/or regulations. This may enable a relatively broad range of use of the cooling system described herein across the world.

Preferably, the rotary compressor may be configured to be operated with one or more of the following refrigerants: R-600a (Isobutane), R-290 (propane), R-718 (water), NH3 (ammoniac) and R-600 (n-butane). Preferably, R600a is used as a refrigerant since it has been deemed as having little to no negative effect on the environment. Thus, R600a may provide a relatively eco-friendly refrigerant for use with the cooling system described herein. This may be helpful in particular for use of the cooling system in remote locations, i.e., where waste disposal and/or waste processing is not as available and/or sophisticated as in more central locations. However, further refrigerants, such as those identified above, may be used with the cooling system described herein. The refrigerant to be used with the cooling system described herein may be selected depending on the heat capacity and/or operating temperature range of the respective refrigerant, as required and/or desired by the respective application of the cooling system described herein.

The refrigeration arrangement further includes at least one condenser which is arranged downstream from the rotary compressor, with respect to a direction of flow of the refrigerant, and configured to receive the pressurised refrigerant. The condenser is configured to dissipate heat from the refrigerant to an ambient which is arranged at least partially outside of the cooling chamber. The condenser may be configured as, or at least may include, a heat exchanger, or at least heat exchanging elements, configured to transfer heat from the refrigerant to the ambient which is arranged at least partially outside of the cooling chamber.

Furthermore, the refrigeration arrangement includes at least one expander arranged downstream from the condenser and configured to expand the refrigerant and at least one evaporator which is arranged downstream from the expander and operatively connected to the cooling chamber to absorb heat from the cooling chamber to the refrigerant. The evaporator may be configured as, or at least may include, a heat exchanger, or at least heat exchanging elements, configured to transfer heat from the cooling chamber to the refrigerant. As detailed above, the cooling system described herein may be configured to provide cooling to any cooling space in general, such as a room of a building. For this purpose, the evaporator may be operatively connectable to the cooling space to absorb heat from the cooling space to the refrigerant.

At least the rotary compressor, the condenser, the expander and the evaporator may be arranged and operatively coupled in at least one refrigerant circuit. The refrigerant circuit may have a fixed flow direction of the refrigerant. Alternatively, the flow direction of the refrigerant may be reversable, e.g., temporarily, e.g., to defrost one or more components in the refrigerant circuit. Reversing the flow direction of the refrigerant may effectively cause the evaporator described above to act as a condenser, i.e. a heat source, and the condenser described above to act as an evaporator, i.e. a heat sink. This may enhance the flexibility of the cooling system, e.g., by being able to alter the locations of heating and cooling of the cooling system described herein.

The cooling system further includes at least one Stirling motor having at least one rotatable driveshaft which is operatively connected to the rotary compressor and configured to rotatably drive the rotary compressor. The rotatable driveshaft of the Stirling motor may be coupled to a rotatable driveshaft of the compressor, preferably be means of at least one coupling element. Preferably, the coupling element is flexible, e.g., to allow the rotatable driveshaft of the Stirling motor and the rotatable driveshaft of the compressor to move relative to each other to a certain degree while maintaining a coupled connection therebetween. This may allow the coupling element to compensate for a potential misalignment of the axes of the rotatable driveshaft of the Stirling motor and the rotatable driveshaft of the compressor. The Stirling motor may be disconnectable from the rotary compressor such that the Stirling motor and/or the rotary compressor may be used independently from each other, e.g., in other processes and/or applications. For thus purpose, the coupling element may enable a relatively quick and simple disconnection of the Stirling motor and the rotary compressor. The driveshaft may include and/or be configured as a crank slider mechanism or a ross-yoke mechanism.

The Stirling motor includes at least one expansion space, in which at least one working medium is arrangeable and expandable, a first piston which is movably arranged at least partially in the expansion space, at least one compression space, in which the working medium is arrangeable and compressible by a second piston which is operatively coupled with the first piston via the driveshaft and movably arranged at least partially in the compression space. The Stirling motor is configured to cooperate with at least one heat source such that the working medium is heatable in the expansion space by the heat source to expand the working medium and drive the first piston to rotatably drive the driveshaft.

By using a Stirling motor to power the cooling system, more specifically the rotary compressor, described herein, the cooling system may be powered non-electrically. Thus, the operation of the cooling system may not be dependent on an availability of electricity from a source of electricity. Hence, this may provide an alternative for electrified cooling systems, e.g., in remote areas in economically poor and non-industrialized countries, such as rural areas, and/or in developed countries.

Moreover, a Stirling motor may be configured to have a relatively high degree of efficiency, e.g., compared to internal combustion engines. Thus, a Stirling motor may provide a relatively cost-efficient means for driving the cooling system, more specifically the rotary compressor. Furthermore, Stirling motors may be used with various heat sources as an energy source for driving the Stirling motors. In particular, Stirling motors may be used with various renewable energy sources, some of which may not be compatible as a power source with other drive mechanisms. Furthermore, Stirling motors are generally a relatively quiet and reliable, i.e., with relatively low maintenance requirements, drive means which may be advantageous for use of the cooling system in remote locations with no or only limited maintenance capabilities.

However, there are one or more sources of inefficiencies in Stirling engines, i.e., one or more thermal, geometrical, or mechanical inefficiencies, including one or more of the following:
side friction of the piston skirt when the piston is sliding along the cylinder liner
relatively large dead volumes (unswept volumes)
conflict between dead volumes and air friction, since less dead space causes more gas friction which becomes more and more important at high rotational speeds
conflict between air leakages through the piston and mechanical friction of the sliding piston
leakage problems caused by high gas pressure

Since the efficiency of a Stirling motor is correlated to the temperature ratio, i.e., of hot temperature to cold temperature, relatively high temperature ratio may be desirable to compensate for these efficiencies. Thus, the system may be heated at relatively high temperatures and chilled at relatively low temperatures. However, working under extreme temperatures may lead to higher maintenance costs and may require more sophisticated and/or more expensive materials.

The proposed Stirling engine according to the present invention is a high-power density Stirling motor which requires lower manufacturing costs and maintenance costs. The Stirling engine according to the present invention may overcome one or more of the above inefficiencies by:
Working under moderate temperatures, therefore not requiring specific materials
Working under moderate pressures, thus lowering maintenance costs and gas leakages
Providing a construction in which dead volume is minimized
Optimizing the heat transfer area by developing 3 efficient heat exchangers
Using self-lubricating seals that reduce mechanical friction between pistons and bores
Choosing the appropriate dimensional specifications of the seals that balance friction losses and gas leakages
Reducing maintenance costs by enabling and providing an oil-free system
Reducing side friction of the pistons through guide rings and long rod ratio

The heat source is preferably solar power. Alternatively, or additionally, the Stirling motor may be configured to cooperate with at least one other heat source to heat the working medium. For instance, the heat source may be at least one or more of the following: hydrocarbon fuel, heat generated by decaying plants, biomass, water vapor, geothermal energy, brine, nuclear energy, waste heat from external processes, and body heat. The Stirling motor may be configured to cooperate with a plurality of different heat sources simultaneously and/or sequentially to heat the working medium.

Different working media may be used with the Stirling motor. The working media may be selected based on the desires and/or needs of the respective application of the cooling system described herein, e.g., to control/influence the operation and/or performance of the Stirling motor. For instance, the working medium may be air, preferably pressurized air, helium or hydrogen. Any compressible/expandable medium may be used as the working medium for the Stirling motor described herein.

The combination of a Stirling motor and a rotary compressor may provide a drive system for driving the refrigeration arrangement which is relatively efficient, provides a relatively large amount of driving power to power the refrigeration arrangement and/or is relatively reliable. Moreover, as described above, the rotary compressor and the Stirling motor are separate components, as opposed to the disclosure of U.S. Pat. No. 6,701,721 B1 which discloses that the free piston of the Stirling engine is integrally formed with a piston of the compressor. This may enable the rotary compressor and the Stirling motor to be disconnected and operated independent from each other, e.g., in other applications and/or processes. In particular in remote locations where devices are not necessarily readily available, flexibly utilizing the available devices, e.g., in various applications and/or different combinations, may be advantageous. The cooling system described herein may be advantageous, inter alia, since the Stirling motor and/or the rotary compressor may be operable lubrication-free. Due to the relatively high efficiency of the cooling system described herein, e.g., of the Stirling motor, the Stirling motor may be operated at low to medium rotations per minute, e.g., at 500 rotations per minute. Such low to medium rpm values and/or value ranges may enable lubrication to be omitted without compromising and/or inoperably damaging the cooling system, in particular the Stirling motor and/or the rotary compressor. Moreover, the Stirling motor and/or the rotary compressor may be configured to generate, or be provided with, a relatively low amount of heat, e.g., compared with internal combustion engines. This may reduce the demand and/or need to transport heat away from the Stirling motor and/or the rotary compressor, e.g., via one or more lubrication media. Moreover, traditional lubricants, such as oil, may be omitted in the Stirling motor, e.g., by using self-lubricating materials, e.g., for sealants provided in the Stirling motor, such as sealing rings provided between the piston(s) and a guide surface for guiding the piston(s), such as an interior surface of a cylinder in which the piston(s) is/are guided.

In addition, the rotary compressor may also be configured to operate lubrication-free. For instance, the rotary compressor may be configured as a scroll compressor including at least two scrolls which move relative to each other to pressurize a fluid therein. Since the two scrolls generally do not touch other, or can at least be configured to not touch each other, friction between the scrolls of the rotary compressor may be prevented, or at least reduced. Hence, the rotary compressor may also be operated lubrication-free.

In addition, the cooling system described herein may enable a clean and environmentally friendly operation and/or manufacturing and/or disposal of the cooling system. The materials used for operating and/or manufacturing the cooling system described herein may have a lower negative impact on the environment than technologies used for operating cooling systems known from the prior art, such as solar photovoltaic panels. In many instances, the devices for such technologies are manufactured using fossil fuels, which have a greater negative impact on the environment than the use of clean and/or renewable energy sources. Moreover, the materials used for constructing the cooling system and/or for operating the cool system described herein may have a greater recyclability than technologies used for operating cooling systems known from the prior art, such as solar photovoltaic panels.

In addition, since the cooling system described herein may be powered entirely from clean and/or renewable energy sources, the cooling system described herein may have a lower negative impact on the environment during operation than known technologies.

The Stirling motor is preferably configured as a Stirling alpha motor, i.e., having two pistons and two separate cylinders, each piston being arranged in a separate cylinder. The two cylinders can be mounted in a V-arrangement, in particular in parallel or perpendicular to each other.

The Stirling motor may be operable, e.g., temporarily, to generate heat, i.e., as a heat pump, to supply thermal energy to another system and/or process on demand. For the operation of a Stirling motor, it may generally be advantageous if the temperature of the compression space is as low as possible to provide a relatively large temperature difference between the expansion space and the compression space. For this purpose, the compression space may be cooled, e.g., by means of a cooling medium. The heat absorbed by said cooling medium may be used, e.g., in another process. Thus, the compression space of the Stirling motor may be used as a source of heat for other processes and/or applications.

The cooling system may be configured to generate electricity, e.g., as a generator and/or alternator. However, preferably, the cooling system is entirely free of electricity, e.g., with respect to a power source for the cooling system and with respect to a form of energy which may be generated by the cooling system itself. Preferably, the cooling system is self-sufficient for at least certain time periods, e.g., for at least 3 hours, preferably at least 4 hours, more preferably at least 5 hours, most preferably at least 6 hours. For this purpose, the cooling system may include an energy storage, preferably at least one energy storage, such as a thermal energy storage, for storing energy which may be consumed by the cooling system when energy is not drawn or may not be drawn from the main heat source, e.g., due to the main heat source not being available. Thus, the cooling system may be operated independently from any external source of energy, i.e., without drawing energy from the external power source, for at least certain periods of time. For instance, the cooling system may be powerable by solar energy and may only need to periodically draw energy from the sun. Preferably, the cooling system may be configured to store energy which is drawn from an external power source, such as solar energy from the sun.

Preferably, the cooling system is capable of being operated without the use of lubrication, such as liquid lubrication media, e.g., oil. This may reduce the maintenance efforts and/or the eco-friendliness, i.e., due to the lack of a potentially environmentally hazardous lubrication medium, of the cooling system described herein.

The cooling system described herein may be used for various cooling purposes, e.g., for household purposes and/or for industrial purposes. According to the respective application of the cooling system, a shape and/or one or more dimensions of the cooling chamber, e.g., a total storage volume of the cooling chamber, may be adapted according to the respective application. The cooling system may be configured to provide cooling to the cooling chamber in a range of different cooling temperatures according to the respective application, e.g., depending on the item(s) which is/are to be stored in the cooling chamber. Preferably, the temperature which is provided to the cooling chamber by the cooling system may be adjustable and/or variable, e.g., automatically, i.e., without user intervention, and/or manually, e.g., via one or more input commands which may be provided by a user, e.g., via a user interface.

Preferably, the cooling system further includes at least one solar energy capturing device which is configured to capture solar energy. The Stirling motor is preferably configured to cooperate with the solar energy capturing device such that the solar energy capturing device can provide thermal energy to the expansion space based on the captured solar energy to heat the working medium. Solar energy may provide a relatively reliable source of energy/heat. Moreover, solar energy as a heat/energy source may require little to no maintenance effort since solar energy is provided self-reliably by the sun.

Preferably, the solar energy capturing device includes an optical device configured to concentrate solar rays, preferably including one or more lenses, preferably Fresnel lenses. The optical device may provide a means for focussing the solar ray in order to increase their intensity. This may increase the amount of heat which may be provided by the solar rays.

Preferably, the cooling system further includes at least one phase change element which is at least partially made of a phase change material (PCM). Preferably, the cooling system includes a cold energy storage system which preferably includes at least one phase change element. The cold energy storage system may accumulate and/or supply energy at a constant temperature via phase change, e.g., of the phase change element, via a latent heat temperature. Transferring heat via phase change and/or a latent heat transfer, may provide a relatively large storage of energy, more specifically a relatively a relatively large density of storage of energy. Moreover, this may provide a relatively consistent heat transfer which may provide a greater controllability of temperatures throughout the system. Preferably, the phase change element is arranged at least partially around the cooling chamber, wherein the phase change element is configured to absorb and store thermal energy from the refrigerant and release the thermal energy on demand to cool the cooling chamber. The PCM may provide a reliable and efficient means for storing thermal energy. The PCM may provide a means for enabling the cooling system to be self-sufficient for at least certain time periods, e.g., for at least 3 hours, preferably at least 4 hours, more preferably at least 5 hours, most preferably at least 6 hours. Thus, the cooling system may be operated independently from any external source of energy, i.e., without drawing energy from the external power source, for at least certain periods of time. For instance, the cooling system may be powerable by solar energy and may only need to periodically draw energy from the sun. Preferably, the PCM may be configured to store thermal energy which is drawn from an external power source, such as solar energy from the sun.

The PCM may be configured to store energy, preferably surplus energy, e.g., surplus solar energy, and release the stored energy on demand, e.g., when the demand for energy by the cooling system exceeds the supply of energy from the heat source. For instance, when using solar power to power the Stirling motor, the cooling system described herein may draw energy from the stored energy in the PCM during night-time, or periods of no or low sunlight in general, when insufficient solar energy is available. Preferably, the phase change material is configured to transition from a solid state to a liquid state and/or vice versa when storing energy and/or when releasing energy. This may be advantageous, e.g., compared with a phase change material in a gaseous state, since the density of a particular material in a gaseous state is generally relatively low compared to the density in a liquid state, and even less than in a solid state.

The PCM of the cold energy storage system is preferably selected from the category of inorganic compounds for thermal, chemical and economic reasons. The PCM may be selected based on one or more thermal properties, e.g., melting temperature (depends on the products stored), latent heat (the highest), thermal conductivity (the highest), density, degree of supercooling, and/or the number of possible freeze/thaw cycles (maintenance and cost issue). The chemical properties sought include compatibility with other materials in the structure, toxicity, and flammability. Among the economic characteristics sought price and accessibility, e.g., availability on the market.

Hydrated salts, i.e., inorganic PCMs, have relatively high latent heats, relatively high thermal conductivity, and are generally much cheaper than the other categories of PCMs. They also have a very narrow melting temperature range, which favours the controllability of the temperature of the refrigerated chamber. Their main disadvantages are the tendency to supercool and the liquid-solid phase segregation which limits the number of qualitative freeze/thaw cycles and can cause corrosion when reacting with metals.

The PCM melting temperature is preferably lower than, at worse equal to, the desired cooling temperature, preferably at least one degree Celsius lower, more preferably at least two degrees Celsius lower, even more preferably at least at least three degree Celsius lower, more preferably at least four degree Celsius lower, more preferably at least five degree Celsius lower.

Preferably, the PCM at least partially surrounds one or more walls of a housing which define the cooling chamber. Alternatively, or additionally, the PCM may be arranged along an inner surface of one or more walls of the housing which face the cooling chamber. Preferably, the energy absorption and/or energy release by the PCM is controllable and/or activatable. The PCM may be activatable automatically, i.e., without user intervention, and/or manually, e.g., via one or more user inputs. Preferably, the PCM is automatically activated when a temperature of the PCM exceeds and/or falls below a temperature threshold, preferably a predetermined temperature threshold. For instance, the PCM may be automatically activatable when a temperature within the cooling chamber or cooling space, respectively, exceeds and/or falls below a temperature threshold. The temperature threshold, preferably predetermined temperature threshold, may be an upper limit of a required and/or desired temperature range in the cooling chamber. The PCM may be automatically activatable when a temperature in the cooling chamber or cooling space exceeds the upper limit of a required and/or desired temperature range in the cooling chamber.

The mass and/or volume of the PCM of the cold energy storage system may be determined, e.g., depending on the required and/or desired cooling capacity of the PCM. The energy supplied by the PCM should meet the heat load requirement. The quantity of PCM needed depends on the quantity of the stored products, the temperature and wind speed outside the cooling chamber, the specific heats, thermal conductivities, densities and emissivity of the materials of the walls of the cooling chamber, as well as the intensity of other biological mechanisms (such as respiration, transpiration, fermentation) that may take place inside the cooling space, etc.

Preferably, the phase change element is configured as a plate-like element through which the refrigerant is guidable to transfer thermal energy from the refrigerant to the phase change element. Preferably, the PCM is cooled by the refrigerant.

Preferably, the phase change element is encapsulated in at least one container through which the refrigerant is guidable to transfer thermal energy from the refrigerant to the phase change element.

Preferably, the refrigeration arrangement is configured to simultaneously guide the refrigerant in a parallel manner in at least two separate circuits to the phase change element and the evaporator, respectively. The circuits preferably merge to a single common refrigerant line upstream from the rotary compressor, e.g., with two separate evaporators. By providing at least two separate circuits through which the refrigerant may be simultaneously guided in a parallel manner, the refrigerant may provide thermal energy to the phase change element as the refrigeration arrangement is being operated, i.e., as the rotary compressor is being driven by the Stirling motor which in turn is being powered by the heat source. This may allow a surplus of thermal energy of the heat source to be utilized efficiently. This configuration may provide a relatively high cooling speed, but at the expense of the complexity, e.g., logistically, technically, and/or economically, of the installation.

Alternatively, to reduce the complexity of the installation, only one circuit may be provided to charge the PCM. The cooling area may be at least one container in which the phase change element may be housed. The cooling chamber may be cooled by heat transfer between the PCM and the ambient air inside the cooling chamber. This configuration may provide a simpler installation, e.g., logistically, technically, and/or economically. In another embodiment, two parallel circuits may be used. One circuit may be used for the PCM and the other circuit may be used for direct cooling of the ambient air of the cooling chamber.

Preferably, the PCM of the cold energy storage system exchanges heat with the refrigerant through an evaporator placed inside the same container as the PCM. Preferably, the evaporator is selected from the following: Coil-type evaporators, coaxial evaporators, plate type evaporators and multi-tube exchangers. Preferably, the evaporator includes a coil through which the refrigerant is guided. The coil may be thermally connected, preferably in connect, with the PCM for heat exchange. Preferably, the material of the coil has a relatively high thermal conductivity, preferably over 220 W·K-1·m-1, more preferably over 380 W·K-1·m-1. The material should also be chemically compatible with the PCM to be cooled.

The operation of the two circuits simultaneously may be selective, i.e., the refrigeration arrangement may also be operated such that only one of the phase change element and the evaporator is fed with refrigerant. For instance, the refrigeration arrangement may include a controllable valve to control the desired and/or optimal operation mode. The valve may be controllable automatically, i.e., without user intervention, and/or manually, e.g., by one or more user inputs, e.g., which may be input via a user interface.

Preferably, the rotary compressor is configured as a scroll compressor.

Alternatively, other rotary compressors may be employed with the cooling system described herein, such as a screw-type or vane-type, lobe-type (roots-style) compressor or a piston compressor having a rotating drivetrain.

Preferably, the cooling system further includes at least one regenerative heat exchanging device configured to at least temporarily store thermal energy by absorbing thermal energy from the working medium and dissipating the thermal energy back to the working medium in a time-separated manner. This may allow surplus thermal energy, e.g., when the energy of the heat source is available in abundance, to be stored and released again. This may allow the available thermal energy to be used more efficiently which may increase a degree of efficiency of the Stirling motor. This may reduce a total energy consumption of the cooling system and/or may increase the cooling capacity of the cooling system with respect to a certain available thermal energy for powering the Stirling motor.

Preferably, the regenerative heat exchanging device has an efficiency of at least 70%, preferably at least 75%, more preferably at least 80%, more preferably at least 85%. The efficiency of the regenerative heat exchanging device may be determined as known in the art. For instance, the efficiency of the regenerative heat exchanging device may be defined as a ratio of heat transferred to the working medium to the heat which would be transferred by an ideal regenerative heat exchanging device without losses. Such a ratio may be calculated by determining the difference of the specific total enthalpy of the working medium Δh₁₂ in [KJ/Kg] on its path from the expansion space to the compression space with respect to a location 2 of the working medium downstream from the regenerative heat exchanging device and a location 1 of the working medium upstream from the regenerative heat exchanging device. Moreover, a difference of the specific total enthalpy of the working medium Δh₃₄ in [KJ/Kg] on its path from the compression space to the expansion space with respect to a location 4 of the working medium downstream from the regenerative heat exchanging device and a location 3 of the working medium upstream from the regenerative heat exchanging device. The efficiency of the regenerative heat exchanging device in [%] may then be calculated by dividing Δh₃₄ by Δh₁₂ multiplied by 100 per equation 1 below. In case the isobaric specific heat capacity of the working medium may be considered to be constant, the efficiency of the regenerative heat exchanging device may be calculated by dividing a temperature difference ΔT₃₄ in Kelvin of the working medium between location 2 and location 1 by a temperature difference ΔT₁₂ in Kelvin of the working medium between location 4 and location 3 per equation 2 below.

$$η = \frac{Δ {h}_{34}}{Δ {h}_{12}} * 100 \qquad ( equation 1 )$$

$$η = \frac{Δ {T}_{34}}{Δ {T}_{12}} * 100 \qquad ( equation 2 )$$

Preferably, the regenerative heat exchanging device includes at least one porous medium for storing thermal energy. The porous medium preferably has a porosity from 50% to 80%, preferably from 60% to 80%, more preferably from 65% to 75%. Preferably, the regenerative heat exchanging device is arranged in a refrigerant flow path between the expansion space and the compression space such that the working medium at least periodically flows through at least a section of the porous medium during operation. A porous medium may be particularly effective and/or efficient in storing thermal energy.

Preferably, the regenerative heat exchanging device includes at least one wire mesh structure, preferably made of a plurality of stainless steel wires, for storing thermal energy, wherein the regenerative heat exchanging device is preferably configured such that the working medium at least periodically flows through at least a section of the wire mesh during operation.

Preferably, the Stirling motor is configured such that the working medium is heatable by one or more of the following heat sources: solar energy, hydrocarbon fuel, heat generated by decaying plants, biomass, water vapor, geothermal energy, brine, nuclear energy, waste heat from external processes, and body heat. By enabling the Stirling motor of the cooling system described herein to be compatible with such a relatively broad range of different heat sources, the flexibility of the cooling system described herein may be increased. Thus, the operation of the cooling system may be adapted to the heat source which is available for the respective application and/or in the respective location of the cooling system in order to be able to power the cooling system in any location, or at least in most locations, e.g., even in remote locations.

Preferably, the Stirling motor includes a hot heat exchanging device, in which preferably the expansion space is at least partially arranged, for transferring heat from the heat source to the expansion space, and a cold heat exchanging device, in which preferably the compression space is at least partially arranged, for transferring heat from the compression space.

The heat exchanging device(s) may be made at least partially of copper. This may allow a relatively high efficiency of the heat exchanging device to be provided since copper has a relatively high thermal conductivity. Thus, the available thermal energy may thereby be utilized efficiently. Additionally, or alternatively, the heat exchanging device(s) may be made of one or more further materials, such as aluminium, in particular for the cold heat exchanging device, steel, etc.

Preferably, the hot heat exchanging device includes a second thermal storage energy system to store the extra heat provided to the Stirling motor and use it on demand, e.g., when needed. The second thermal storage energy system may be configured to store enough energy to power the cooling system for at least 1 hour, preferably of at least 2 hours, more preferably of at least 3 hours, more preferably of at least 4 hours, more preferably of at least 5 hours, more preferably of at least 6 hours.

The second thermal storage energy system may include a hermetically sealed container mounted on the hot heat exchanging device of the Stirling motor. The container may be made of material which has a relatively high thermal conductivity, e.g., copper, aluminium, graphite, graphene, and their alloys. The container may be filled with at least one heat carrier and at least one accumulator material, e.g., one or more phase change materials, such as aluminium and its alloys, in particular the aluminium-magnesium alloy, or a material with an appropriate specific heat capacity, e.g., water in liquid or gaseous form, graphite, copper, and aluminium in granular form.

Alternatively, the second thermal storage energy system may be configured to trap energy therewithin. The second thermal storage energy system may include at least one cylindrical container with double glazing and configured to include a vacuum therein. The e vacuum may have a pressure of less than 1 mBar.

Preferably, the Stirling motor includes a first cylinder, which at least partially defines the expansion space and which at least partially guides the first piston, and at least a second cylinder, which at least partially defines the compression space and which at least partially guides the second piston.

Preferably, the first and second cylinders may be made of cast iron. Alternatively, the cylinders may be made of stainless steel, steel, glass, carbon or aluminum. A composite material may also be used, such as carbon fiber. Guiding surfaces of the first and second cylinders may be treated/coated to reduce friction between the pistons and the respective cylinder. Preferably, the material and/or configuration, e.g., the dimensions and/or shape, of the cylinders provide a balance between structural stability and heat conducting capabilities, e.g., to limit heat trap in the cylinders to avoid damage to components of the Stirling motor, but also to limit excessive heat loss from the expansion space, which may decrease the efficiency of the Stirling motor.

The dead volume in Stirling motors is inevitable, yet it needs to be minimized to reach higher efficiencies. To minimize this portion of gas, preferably, the two cylinders are in V-arrangement. Furthermore, the dimensional specifications of the hot and cold exchangers, e.g., the diameter, the length, and the number of tubes, and the manifolds between the different components of the motor may be optimized such as to minimize the dead volume without compromising heat transfer and heat losses from the working medium.

Preferably, the Stirling motor includes at least one sealing element configured to provide a seal between the first cylinder and the first piston and/or between the second cylinder and the second piston, respectively. The sealing element is preferably a sealing ring attached to an inner wall of the respective cylinder facing the respective piston or to an outer wall of the respective piston facing the respective cylinder. The sealing element is preferably made of polytetrafluorethylene (PTFE). The sealing element may be configured as a composite ring which includes an inner O-ring and an outer seal ring. The inner O-ring may be made of fluoroelastomer (FKM). The outer seal ring may be made of polytetrafluorethylene (PTFE). An exemplary sealing ring which may be used is an o-ring made of fluoroelastomer (FKM) which is available from DuPont Performance Elastomers, which is also known under its trademark name Viton®. The Stirling motor may include a plurality of sealing elements, e.g., sealing rings, e.g., a plurality of sealing rings made of PTFE and/or FKM. Providing one or more sealing elements/rings may provide a seal between the respective cylinder and piston, preferably in substantially leak-tight manner and/or may reduce friction between the respective piston and the respective cylinder. This may reduce friction within the Stirling motor when the Stirling motor is operated without lubrication, such as oil. This may increase the lifetime, reduce maintenance efforts and increase the robustness of the cooling system described herein. Within this context, PTFE and/or FKM is/are particularly advantageous since PTFE and/or FKM is/are a self-lubricating material.

The dimensional specifications of the rings are critical. Hence, a balance between gas sealing and friction at the rings over the cylinder liner must be found.

A guide ring may be provided to reduce mechanical friction between the pistons and cylinder bores. The guide ring may absorb transverse forces that occur during piston motion. Preferably, the guide ring is made of PTFE.

Alternatively, the sealing element may be omitted, i.e., a separate sealing element may not be provided between the first cylinder and the first piston and/or between the second cylinder and the second piston, respectively. The Stirling motor may include one or more guide elements configured to guide the first piston within the first cylinder and and/or the second piston within the second cylinder. The guide elements may be configured to reduce friction between the respective piston and the respective cylinder, e.g., by reducing contact between the respective piston and the respective cylinder. The guide elements may include one or more guide rings. The one or more guide rings may be made from PTFE. However, the one or more guide rings may be made from other suitable materials, such as for example fluoroelastomer (FKM) which is available from DuPont Performance Elastomers, which is also known under its trademark name Viton®.

Preferably, the first piston at least one extension, e.g., “a crown”, configured to shield or protect one or more seals of the first piston from heat, in particular excess heat. Preferably, the extension is made of a material that is lightweight, heat resistant and insulating. Preferably, the crown may be made of a ceramic material.

The driveshaft may be provided with one or more counterweights configured to at least partially compensate for the weight of moving components. The counterweights may be disc-shaped cylindrical sections positioned in a rod journal of the driveshaft. The balance of the driveshaft guarantees smoother operations, less vibrations and higher performance of the engine. Dynamic balance is ensured by calculating the required weight that compensates the total rotating weight and a portion of the reciprocating weight. The rotating parts may include the driveshaft, the lower half of piston rod, and rod bearings. The reciprocating parts may include the piston(s), the piston components, and the upper half of the connecting rod(s).

Alternatively, or additionally, the Stirling motor may include a crankcase. Preferably, the crankcase at least partially forms the first and/or second cylinder. Preferably, a rotatable driveshaft, which is preferably connected to the first and/or second cylinder, extends through the crankcase. Preferably, the crankcase is configured to pressurize the working medium therein. Preferably, the crankcase is configured to pump the working medium into the first cylinder and/or into the second cylinder. Preferably, an upper surface of each piston, i.e., a surface which faces away from the crankcase, and a lower surface of each piston, i.e., a surface which faces the crankcase, are used as working surfaces and configured to operatively interact with the working medium. Preferably, the crankcase is free of lubrication media, e.g., oil. Preferably, the gas inside the crankcase (space bellow the pistons) is pressurized to the mean cycle pressure which may help to release or at least partially equalize a pressure difference between the gas above and below the piston, which may reduce gas leakages.

Preferably, the crankcase is configured to provide a space, preferably a buffer space, arranged at least partially between the first cylinder and the second cylinder. The crankcase may be configured such that a pressure may be generated therein such that a leakage of the working medium between the respective piston and a wall of the respective cylinder in which the piston is at least partially arranged, e.g., from the expansion space and/or the compression space to the crankcase, may be prevented or at least reduced. Thus, the crankcase may pressurize at least a first side of the respective piston which is substantially opposite from a second side of the piston which faces the expansion space and/or the compression space, respectively. The Stirling motor may include a pressure control mechanism configured to control and/or adjust a pressure within the crankcase, e.g., to regulate and/or limit a pressure buildup in the crankcase.

Preferably, the cooling system further includes one or more control devices configured to control, and optionally adjust, one or more of the following parameters: a rotational speed of the Stirling motor, a power of the Stirling motor, a torque of the Stirling motor, a compression ratio of the rotary compressor, a rotational speed of the rotary compressor, a temperature of the working medium, a pressure of the working medium, a flow rate of the working medium, a pressure of the refrigerant, a flow rate of the refrigerant, an amount of energy transferred from the heat source to the expansion space, and a temperature within the cooling chamber. The one or more control devices may be configured to control, and optionally adjust, one or more of the above-identified parameters manually by a user and/or without user intervention, i.e., automatically.

Preferably, the expander is configured as a valve, preferably a capillary valve.

Preferably, the cooling system further includes one or more insulation elements, preferably configured as panels, such as polyurethane panels, arranged at least partially about the cooling chamber to reduce a heat exchange between the cooling chamber and the environment surrounding the cooling chamber. This may increase the efficiency of the cooling system described herein.

Preferably, one or more side walls and/or at least one roof of the cooling chamber may be provided with the insulation elements. Preferably, the insulation elements are made of three layers of material: an outer cladding, a layer of highly insulating material and an inner layer. In this configuration, the outer cladding may form a shell of the system. Ideally, the outer and inner layers should be made of a sufficiently strong and rigid material, such as metal or steel. The insulating material may be the main barrier to heat gain from the outside of the cooling chamber. Thus, preferably, the insulating material has the lowest possible thermal conductivity and a sufficient thickness. The insulating material may have a thermal conductivity preferably of no more than 0.022 W·m-1·K-1 and at least 80 mm of thickness. Examples include extruded polystyrene, expanded polystyrene, polyurethane foam, wood fibre, sheep's wool, etc.

A floor of the cooling chamber is configured to support a load of the entire structure and all the elements that will be contained in the cooling chamber, including, e.g., shelves on which objects to be cooled may be stored, an air evaporator and an energy storage system.

The insulation elements are preferably insulation panels having a thickness of at least 80 mm.

Preferably, the rotary compressor and/or the Stirling motor is/are removably integrated into the cooling system such that the rotary compressor and/or the Stirling motor is/are detachable from the cooling system on demand. This may allow the rotary compressor and/or the Stirling motor to be separated from the other components of the cooling system, e.g., to facilitate servicing the rotary compressor and/or the Stirling motor and/or to replace the rotary compressor and/or the Stirling motor. Moreover, the rotary compressor and/or the Stirling motor may be separated from the cooling system in order to be used for other purposes and/or with a different system and/or a different process. This may increase the flexibility of the cooling system, in particular the rotary compressor and/or the Stirling motor.

In particular, one motor and/or one compressor may be employed for a plurality of cooling systems.

Preferably, the cooling chamber has a storage volume of at least 0.2 m3, preferably at least 0.4 m3, more preferably at least 0.6 m3, more preferably at least 0.8 m3, most preferably at least 1 m3.

Preferably, the cooling system further includes at least one solar tracking device configured to maximize the degree of solar energy which can be captured by the solar energy capturing device. This may allow the amount of solar energy which can be collected and used with the cooling system to be increased. As a result, the operation of the cooling system may be optimized and/or the amount of surplus solar energy which may be stored by the cooling system may be increased.

Preferably, the solar tracking device is configured to follow the path of the sun to maximize the degree of solar energy which can be captured by the solar energy capturing device.

Preferably, the solar tracking device is driven only mechanically.

Preferably, the solar tracking device may be operated non-electrically. Preferably, the operation of the solar tracking device is entirely free of electricity. The solar tracking system therefore does not require electrical power. The solar tracking device may movably drive one or more lenses, preferably Fresnel lenses, and/or one or more mirrors, preferably one or more spherical, plane or parabolic mirrors.

Preferably, the solar tracking device is driven by potential energy. Potential energy may refer to the energy held by an object because of its position relative to other objects. Thus, for instance, energy for powering the solar tracking device may be drawn from one or more objects which change their position, e.g., by being moved due to gravitational forces in the direction of gravity. For instance, the solar tracking device may include a scale-like element and/or a receptacle which is pushed further in the direction of gravity by the weight of one or more driving objects as the driving objects are accumulated on the scale-like element or receptacle. In particular, the solar tracking device may function in an hourglass manner in which the driving objects are successively moved from a first height to a second height which is less than the first height.

Preferably, the solar tracking device is configured to receive at least one solar energy capturing device, wherein the solar energy capturing device preferably includes an optical device including one or more lenses, preferably Fresnel lenses, and/or one or more mirrors configured to concentrate solar rays. The solar tracking device is preferably configured to align or position the solar energy capturing device, preferably one or more lenses and/or one or more mirrors of the solar energy capturing device, to maximize the degree of solar energy which can be captured by the solar energy capturing device.

Preferably, the solar tracking device is configured to rotatably and/or translationally move the solar energy capturing device or at least an element thereof, to maximize the degree of solar energy which can be captured by the solar energy capturing device. Preferably, the solar tracking device is configured to rotatably and/or translationally move the solar energy capturing device or at least an element thereof in one or more degrees of freedom.

Preferably, the solar tracking device is configured such that a speed and/or a direction of the rotational and/or translational movement of the solar energy capturing device by means of the solar tracking device is adjustable. The speed and/or a direction of the rotational and/or translational movement of the solar energy capturing device may be manually, i.e., by a user, and/or automatically, i.e., without user intervention, adjustable.

Preferably, the solar tracking device is configured to receive one or more movable driving objects, preferably rollable or slidable driving objects, preferably spherical driving objects, preferably metal marbles. The solar tracking device is preferably configured to guide the driving objects from a first state of potential energy at a first height, with respect to the direction of gravity, to a second state of potential energy at a second height, with respect to the direction of gravity, wherein the first state of potential energy and the first height are greater than the second state of potential energy and the second height, respectively, such that the driving objects drive the solar energy capturing device into movement as the driving objects are guided from the first state of potential energy at the first height to the second state of potential energy at the second height to follow the path of the sun. As described above, the solar tracking device may include a scale-like element or receptacle which is pushed further in the direct of direction by the weight of the driving objects as the driving objects are accumulated on the scale-like element. In particular, the solar tracking device may function in an hourglass manner in which the driving objects are successively moved from a first height to a second height which is less than the first height to drive movement of the solar energy capturing device by a change in the potential energy of the driving objects, more specifically by the weight of the driving objects as they successively accumulate on the scale-like element or receptacle.

The driving objects may have a fixed flow rate or a variable flow rate through the solar tracking device. The flow rate may at least partially determine the power which may be generated by the solar tracking device to move the solar energy capturing device or at least an element thereof. Preferably, a higher flow rate of the driving objects may generate more power than a lower flow rate.

Preferably, the solar tracking device includes at least one opening through which the driving objects are moveable at a moving speed, wherein preferably the moving speed is variable, preferably by varying one or more properties, preferably at least a cross-section, of the opening. Preferably, the opening has the smallest cross-section in a path of the driving objects through the solar tracking device. The opening may have a fixed cross-section. Alternatively, the cross-section of the opening may be variable. The cross-section of the opening may be manually, i.e., by a user input, or automatically, i.e., without user intervention, variable.

Preferably, the cooling system is configured to provide an average temperature in the cooling chamber of 10° C. or less, preferably 6° C. or less, more preferably 2° C. or less, more preferably 0° C. or less, more preferably −2° C. or less, more preferably −4° C. or less, more preferably −6° C. or less, most preferably −8° C. or less.

The object set out at the beginning is also solved by a compressor system according to a second aspect of the invention. The compressor system is defined by the features of independent claim 10. Variations and further developments are defined by the features of the respective dependent claims.

The features, configurations and/or advantages described above in relation to the cooling system according to the first aspect of the invention also apply to the compressor system according to the second aspect of the invention accordingly.

The compressor system includes at least one rotary compressor for pressurising at least one refrigerant and at least one Stirling motor having at least one rotatable driveshaft which is operatively connected to the rotary compressor and configured to rotatably drive the rotary compressor.

The Stirling motor includes at least one expansion space, in which at least one working medium is arrangeable, a first piston which is movably arranged at least partially in the expansion space, a compression space and a second piston which is operatively coupled with the first piston by the driveshaft and movably arranged at least partially in the compression space. The Stirling motor is configured to cooperate with at least one heat source such that the working medium is heatable in the expansion space by the heat source to expand the working medium and drive the first piston to rotatably drive the driveshaft.

The compressor system may be couplable to a variety of different drive sources and cooperate with the respective drive sources to power the compressor system by the respective drive sources.

Preferably, the compressor system further includes at least one solar energy capturing device which is configured to capture solar energy. The Stirling motor is preferably configured to cooperate with the solar energy capturing device such that the solar energy capturing device can provide thermal energy to the expansion space based on the captured solar energy to heat the working medium.

Preferably, the rotary compressor is configured as a scroll compressor.

Alternatively, other positive displacement compressors may be used, such as a screw-type or vane-type, lobe-type (roots-style) compressor or a piston compressor having a reciprocating drivetrain.

Preferably, the compressor system further includes at least one regenerative heat exchanging device configured to at least temporarily store thermal energy by absorbing thermal energy from the working medium and dissipating the thermal energy back to the working medium in a time-separated manner during operation.

Preferably, the regenerative heat exchanging device includes at least one porous medium for storing thermal energy, wherein the porous medium has a porosity from 50% to 80%, preferably from 60% to 80%, more preferably from 65% to 75%, wherein preferably the regenerative heat exchanging device is arranged in a flow path between the expansion space and the compression space such that working medium at least periodically flows through at least a section of the porous medium during operation.

Preferably, the regenerative heat exchanging device includes at least one wire mesh structure, preferably made of a plurality of stainless steel wires, for storing thermal energy. The regenerative heat exchanging device is preferably configured such that the working medium at least periodically flows through at least a section of the wire mesh during operation.

Preferably, the Stirling motor is configured such that the working medium is heatable by one or more of the following heat sources: solar energy, hydrocarbon fuel, heat generated by decaying plants, biomass, water vapor, geothermal energy, brine, nuclear energy, waste heat from external processes, and body heat.

Preferably, the Stirling motor includes a hot heat exchanging device, in which preferably the expansion space is at least partially arranged, for transferring heat to the expansion space, and a cold heat exchanging device, in which preferably the compression space is at least partially arranged, for transferring heat from the compression space.

Preferably, the Stirling motor includes a first cylinder, which at least partially defines the expansion space and which at least partially guides the first piston, and at least a second cylinder, which at least partially defines the compression space and which at least partially guides the second piston.

Preferably, the first and second cylinders may be made of cast iron. One or more surfaces of the first and second cylinders which guide the first and second piston, respectively, may be treated/coated to reduce friction between the respective piston and the respective cylinder.

Preferably, the Stirling motor includes at least one sealing element configured to provide a seal between the first cylinder and the first piston and/or between the second cylinder and the second piston, respectively, wherein the sealing element is preferably a sealing ring attached to an inner wall of the respective cylinder facing the respective piston or to an outer wall of the respective piston facing the respective cylinder, wherein the sealing element is preferably made of polytetrafluorethylene (PTFE).

The object set out at the beginning is also solved by a solar tracking device according to a third aspect of the invention. The solar tracking device is defined by the features of independent claim 13. Variations and further developments are defined by the features of the respective dependent claims.

The features, configurations and/or advantages described above in relation to the cooling system and/or the compressor system according to the first aspect and the second aspect of the invention, respectively, also apply to the compressor system according to the solar tracking device.

The solar tracking device is configured to follow the path of the sun to optimize the degree of solar energy which can be captured by a solar energy capturing device. The solar tracking device is driven only mechanically. The solar tracking system may be powered by gravity and therefore does not require electrical power.

Preferably, the solar tracking device is driven by potential energy.

Preferably, the solar tracking device is configured to receive at least one solar energy capturing device. The solar energy capturing device preferably includes an optical device including one or more lenses, preferably Fresnel lenses, or one or more mirrors, preferably parabolic mirrors, configured to concentrate solar rays. The solar tracking device is preferably configured to align the solar energy capturing device, preferably one or more lenses or mirrors of the solar energy capturing device, to maximize the degree of solar energy which can be captured by the solar energy capturing device.

Preferably, the solar tracking device is configured to rotatably and/or translationally move the solar energy capturing device or at least an element thereof, to maximize the degree of solar energy which can be captured by the solar energy capturing device.

Preferably, the solar tracking device is configured such that a speed and/or a direction of the rotational and/or translational movement of the solar energy capturing device by means of the solar tracking device is adjustable.

Preferably, the solar tracking device is configured to receive one or more movable driving objects, preferably rollable or slidable driving objects, preferably ball-like driving objects, preferably metal marbles. For example, at least 10, preferably at least 50 or at least 100 of the driving objects may be provided. The solar tracking device is preferably configured to guide the driving objects from a first state of potential energy at a first height, with respect to the direction of gravity, to a second state of potential energy at a second height, with respect to the direction of gravity, wherein the first state of potential energy and the first height are greater than the second state of potential energy and the second height, respectively, such that the driving objects drive the solar energy capturing device into movement as the driving objects are guided from the first state of potential energy at the first height to the second state of potential energy at the second height to follow the path of the sun.

The invention relates, in particular, to the following aspects:

1. A cooling system, including:
a refrigeration arrangement, including:
   at least one compressor, preferably a rotary compressor, for pressurising at least one refrigerant;
   at least one condenser which is arranged downstream from the rotary compressor, with respect to a direction of flow of the refrigerant, and configured to receive the pressurised refrigerant, wherein the condenser is configured to dissipate heat from the refrigerant to an ambient;
   at least one expander arranged downstream from the condenser and configured to expand the refrigerant; and
   at least one evaporator which is arranged downstream from the expander and operatively connectable to a cooling space to absorb heat from the cooling space to the refrigerant, wherein preferably the cooling space includes a cooling chamber configured to receive one or more objects to be cooled;
at least one Stirling motor having at least one rotatable driveshaft which is operatively connected to the compressor and configured to drive, preferably rotatably drive, the rotary compressor;
wherein the Stirling motor includes at least one expansion space, in which at least one working medium is arrangeable and expandable, a first piston which is movably arranged at least partially in the expansion space, at least one compression space, in which the working medium is arrangeable and compressible by a second piston which is operatively coupled with the first piston via the driveshaft and movably arranged at least partially in the compression space, wherein the Stirling motor is configured to cooperate with at least one heat source such that the working medium is heatable in the expansion space by the heat source to expand the working medium and drive the first piston to rotatably drive the driveshaft.

2. The cooling system according to aspect 1, further including at least one solar energy capturing device which is configured to capture solar energy, wherein the Stirling motor is configured to cooperate with the solar energy capturing device such that the solar energy capturing device can provide energy, preferably thermal energy, to the expansion space based on the captured solar energy to heat the working medium.

3. The cooling system according to aspect 2, wherein the solar energy capturing device includes an optical device including one or more lenses, preferably Fresnel lenses, configured to concentrate solar rays.

4. The cooling system according to any of aspects 1 to 3, further including at least one phase change element which is at least partially made of a phase change material (PCM), wherein the phase change element is arranged at least partially around the cooling chamber, wherein the phase change element is configured to absorb and store thermal energy from the refrigerant and release the thermal energy on demand to cool the cooling chamber.

5. The cooling system according to aspect 4, wherein the phase change element is configured as a plate-like element through which the refrigerant is guidable to transfer thermal energy from the refrigerant to the phase change element.

6. The cooling system according to aspect 4 or 5, wherein the refrigeration arrangement is configured to simultaneously guide the refrigerant in a parallel manner in at least two separate circuits to the phase change element and the evaporator, respectively, wherein the circuits merge to a single common refrigerant line upstream from the rotary compressor.

7. The cooling system according to any of the preceding aspects, wherein the rotary compressor is configured as a scroll compressor.

8. The cooling system according to any of the preceding aspects, further including at least one regenerative heat exchanging device configured to at least temporarily store thermal energy by absorbing thermal energy from the working medium and dissipating the thermal energy back to the working medium in a time-separated manner.

9. The cooling system according to aspect 8, wherein the regenerative heat exchanging device includes at least one porous medium for storing thermal energy, wherein the porous medium has a porosity from 50% to 80%, preferably from 60% to 80%, more preferably from 65% to 75%, wherein preferably the regenerative heat exchanging device is arranged in a refrigerant flow path between the expansion space and the compression space such that the working medium at least periodically flows through at least a section of the porous medium during operation.

10. The cooling system according to aspect 8 or 9, wherein the regenerative heat exchanging device includes at least one wire mesh structure, preferably made of a plurality of stainless steel wires, for storing thermal energy, wherein the regenerative heat exchanging device is preferably configured such that the working medium at least periodically flows through at least a section of the wire mesh during operation.

11. The cooling system according to any of the preceding aspects, wherein the Stirling motor is configured such that the working medium is heatable by one or more of the following heat sources: solar energy, hydrocarbon fuel, heat generated by decaying plants, biomass, water vapor, geothermal energy, brine, nuclear energy, waste heat from external processes, and body heat.

12. The cooling system according to any of the preceding aspects, wherein the Stirling motor includes a hot heat exchanging device, in which preferably the expansion space is at least partially arranged, for transferring heat from the heat source to the expansion space, and a cold heat exchanging device, in which preferably the compression space is at least partially arranged, for transferring heat from the compression space.

13. The cooling system according to aspect 12, wherein the hot heat exchanging device includes a thermal energy storage system which includes at least one container filled with a thermal storage material to store heat provided to the Stirling motor by the solar energy capturing device.

14. The cooling system according to any of the preceding aspects, wherein the Stirling motor includes a first cylinder, which at least partially defines the expansion space and which at least partially guides the first piston, and at least a second cylinder, which at least partially defines the compression space and which at least partially guides the second piston, preferably wherein the first cylinder and the second cylinder are in a V-arrangement.

15. The cooling system according to any of the preceding aspects, wherein the Stirling motor includes a crankcase on which the first cylinder and the second cylinder are mounted, wherein the driveshaft extends at least partially through the crankcase, and wherein the crankcase is configured to be filled with a pressurized fluid.

16. The cooling system according to aspect 14 or 15, wherein the Stirling motor includes at least one sealing element configured to provide a seal between the first cylinder and the first piston and/or between the second cylinder and the second piston, respectively, wherein the sealing element is preferably a sealing ring attached to an inner wall of the respective cylinder facing the respective piston or to an outer wall of the respective piston facing the respective cylinder, wherein the sealing element is preferably made of polytetrafluorethylene (PTFE) and/or fluoroelastomer (FKM), preferably wherein the first piston and/or the second piston include one or more grooves and at least two composite rings are mounted one above the other in the same groove of the one or more grooves, for each piston, preferably wherein a guide ring made of PTFE is also provided, preferably mounted in a second groove of the one or more grooves of the first piston and the second piston.

17. The cooling system according to any of the preceding aspects, further including one or more control devices configured to control, and optionally adjust, one or more of the following parameters: a rotational speed of the Stirling motor, a power of the Stirling motor, a torque of the Stirling motor, a compression ratio of the rotary compressor, a rotational speed of the rotary compressor, a temperature of the working medium, a pressure of the working medium, a flow rate of the working medium, a pressure of the refrigerant, a flow rate of the refrigerant, an amount of energy transferred from the heat source to the expansion space, a temperature within the cooling chamber, a pressure of a fluid in a buffer space, and a pressure of the refrigerant.

18. The cooling system according to any of the preceding aspects, wherein the expander is configured as a valve, preferably a capillary valve.

19. The cooling system according to any of the preceding aspects, further including one or more insulation elements, preferably polyurethane panels, arranged at least partially about the cooling chamber to reduce a heat exchange between the cooling chamber and the environment surrounding the cooling chamber.

20. The cooling system according to any of the preceding aspects, wherein the rotary compressor and/or the Stirling motor is/are removably integrated into the cooling system and/or the Stirling motor such that the rotary compressor and/or the Stirling motor is/are detachable from the cooling system on demand.

21. The cooling system according to any of the preceding aspects, wherein the cooling chamber has a storage volume of at least 0.2 m3, preferably at least 0.4 m3, more preferably at least 0.6 m3, more preferably at least 0.8 m3, most preferably at least 1 m3.

22. The cooling system according to any of aspects 2 to 21, further including at least one solar tracking device configured to maximize the degree of solar energy which can be captured by the solar energy capturing device.

23. The cooling system according to aspect 22, wherein the solar tracking device is configured to follow the path of the sun to maximize the degree of solar energy which can be captured by the solar energy capturing device.

24. The cooling system according to aspect 22 or 23, wherein the solar tracking device is driven only mechanically.

25. The cooling system according to any of aspects 22 to 24, wherein the solar tracking device is driven by potential energy.

26. The cooling system according to any of aspects 22 to 25, wherein the solar tracking device is configured to receive at least one solar energy capturing device, wherein the solar energy capturing device preferably includes an optical device including one or more lenses, preferably Fresnel lenses, configured to concentrate solar rays, wherein the solar tracking device is configured to align the solar energy capturing device, preferably one or more lenses of the solar energy capturing device, to maximize the degree of solar energy which can be captured by the solar energy capturing device.

27. The cooling system according to aspect 26, wherein the solar tracking device is configured to rotatably and/or translationally move the solar energy capturing device or at least an element thereof, to maximize the degree of solar energy which can be captured by the solar energy capturing device.

28. The cooling system according to aspect 27, wherein the solar tracking device is configured such that a speed and/or a direction of the rotational and/or translational movement of the solar energy capturing device by means of the solar tracking device is adjustable.

29. The cooling system according to any of aspects 22 to 28, wherein the solar tracking device is configured to receive one or more movable driving objects, preferably rollable or slidable driving objects, preferably ball-like driving objects, preferably metal marbles, wherein the solar tracking device is configured to guide the driving objects from a first state of potential energy at a first height, with respect to the direction of gravity, to a second state of potential energy at a second height, with respect to the direction of gravity, wherein the first state of potential energy and the first height are greater than the second state of potential energy and the second height, respectively, such that the driving objects drive the solar energy capturing device into movement as the driving objects are guided from the first state of potential energy at the first height to the second state of potential energy at the second height to follow the path of the sun.

30. The cooling system according to aspect 29, wherein the solar tracking device includes at least one opening through which the driving objects are moveable at a moving speed, wherein preferably the moving speed is variable, preferably by varying one or more properties, preferably at least a cross-section, of the opening.

31. The cooling system according to any of the preceding aspects, wherein the cooling system is configured to provide an average temperature in the cooling chamber of 10° C. or less, preferably 6° C. or less, more preferably 2° C. or less, more preferably 0° C. or less, more preferably −2° C. or less, more preferably −4° C. or less, more preferably −6° C. or less, most preferably −8° C. or less.

32. A compressor system, including:
at least one rotary compressor for pressurising at least one refrigerant;
at least one Stirling motor having at least one rotatable driveshaft which is operatively connected to the rotary compressor and configured to rotatably drive the rotary compressor;
wherein the Stirling motor includes at least one expansion space, in which at least one working medium is arrangeable, a first piston which is movably arranged at least partially in the expansion space, a compression space and a second piston which is operatively coupled with the first piston by the driveshaft and movably arranged at least partially in the compression space, wherein the Stirling motor is configured to cooperate with at least one heat source such that the working medium is heatable in the expansion space by the heat source to expand the working medium and drive the first piston to rotatably drive the driveshaft.

33. The compressor system according to aspect 32, further including at least one solar energy capturing device which is configured to capture solar energy, wherein the Stirling motor is configured to cooperate with the solar energy capturing device such that the solar energy capturing device can provide energy, preferably thermal energy, to the expansion space based on the captured solar energy to heat the working medium.

34. The compressor system according to aspect 32 or 33, wherein the rotary compressor is configured as a scroll compressor.

35. The compressor system according to any of aspects 32 to 34, further including at least one regenerative heat exchanging device configured to at least temporarily store thermal energy by absorbing thermal energy from the working medium and dissipating the thermal energy back to the working medium in a time-separated manner during operation.

36. The compressor system according to aspect 35, wherein the regenerative heat exchanging device includes at least one porous medium for storing thermal energy, wherein the porous medium has a porosity from 50% to 80%, preferably from 60% to 80%, more preferably from 65% to 75%, wherein preferably the regenerative heat exchanging device is arranged in a flow path between the expansion space and the compression space such that working medium at least periodically flows through at least a section of the porous medium during operation.

37. The compressor system according to aspect 35 or 36, wherein the regenerative heat exchanging device includes at least one wire mesh structure, preferably made of a plurality of stainless steel wires, for storing thermal energy, wherein the regenerative heat exchanging device is preferably configured such that the working medium at least periodically flows through at least a section of the wire mesh during operation.

38. The compressor system according to any of aspects 32 to 37, wherein the Stirling motor is configured such that the working medium is heatable by one or more of the following heat sources: solar energy, hydrocarbon fuel, heat generated by decaying plants, biomass, water vapor, geothermal energy, brine, nuclear energy, waste heat from external processes, and body heat.

39. The compressor system according to any of aspects 32 to 38, wherein the Stirling motor includes a hot heat exchanging device, in which preferably the expansion space is at least partially arranged, for transferring heat to the expansion space, and a cold heat exchanging device, in which preferably the compression space is at least partially arranged, for transferring heat from the compression space.

40. The compressor system according to any of aspects 32 to 39, wherein the Stirling motor includes a first cylinder, which at least partially defines the expansion space and which at least partially guides the first piston, and at least a second cylinder, which at least partially defines the compression space and which at least partially guides the second piston.

41. The compressor system according to aspect 40, wherein the Stirling motor includes at least one sealing element configured to provide a seal between the first cylinder and the first piston and/or between the second cylinder and the second piston, respectively, wherein the sealing element is preferably a sealing ring attached to an inner wall of the respective cylinder facing the respective piston or to an outer wall of the respective piston facing the respective cylinder, wherein the sealing element is preferably made of polytetrafluorethylene (PTFE).

42. A solar tracking device configured to follow the path of the sun to optimize the degree of solar energy which can be captured by a solar energy capturing device, wherein the solar tracking device is driven only mechanically.

43. The solar tracking device according to aspect 42, wherein the solar tracking device is driven by potential energy.

44. The solar tracking device according to aspect 42 or 43, wherein the solar tracking device is configured to receive at least one solar energy capturing device, wherein the solar energy capturing device preferably includes an optical device including one or more lenses, preferably Fresnel lenses, configured to concentrate solar rays, wherein the solar tracking device is configured to align the solar energy capturing device, preferably one or more lenses of the solar energy capturing device, to maximize the degree of solar energy which can be captured by the solar energy capturing device.

45. The solar tracking device according to aspect 44, wherein the solar tracking device is configured to rotatably and/or translationally move the solar energy capturing device or at least an element thereof, to maximize the degree of solar energy which can be captured by the solar energy capturing device.

46. The solar tracking device according to aspect 45, wherein the solar tracking device is configured such that a speed and/or a direction of the rotational and/or translational movement of the solar energy capturing device by means of the solar tracking device is adjustable.

47. The solar tracking device according to any of aspects 42 to 46, wherein the solar tracking device is configured to receive one or more movable driving objects, preferably rollable or slidable driving objects, preferably ball-like driving objects, preferably metal marbles, wherein the solar tracking device is configured to guide the driving objects from a first state of potential energy at a first height, with respect to the direction of gravity, to a second state of potential energy at a second height, with respect to the direction of gravity, wherein the first state of potential energy and the first height are greater than the second state of potential energy and the second height, respectively, such that the driving objects drive the solar energy capturing device into movement as the driving objects are guided from the first state of potential energy at the first height to the second state of potential energy at the second height to follow the path of the sun.

### DETAILED DESCRIPTION OF FIGURES

Preferred embodiments of the present invention are further elucidated below with reference to the figures. The described embodiments do not limit the present invention.

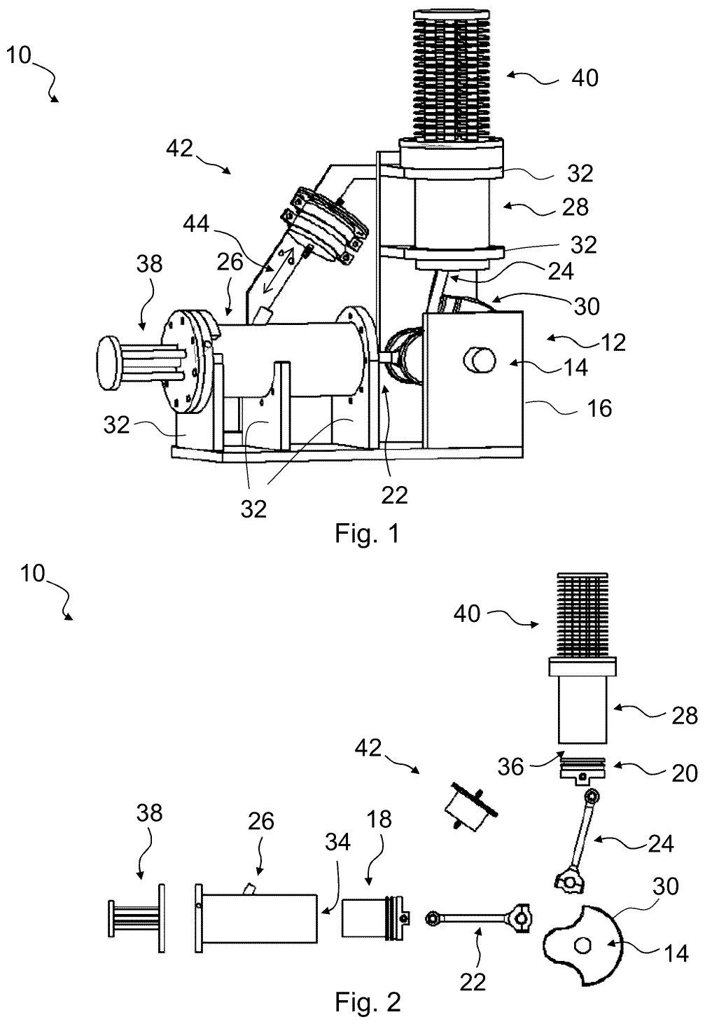

FIG. 1 shows, in a schematic perspective view, a Stirling motor for driving a compressor system according to an aspect of the invention;

FIG. 2 shows a schematic exploded view of the Stirling motor shown in FIG. 1;

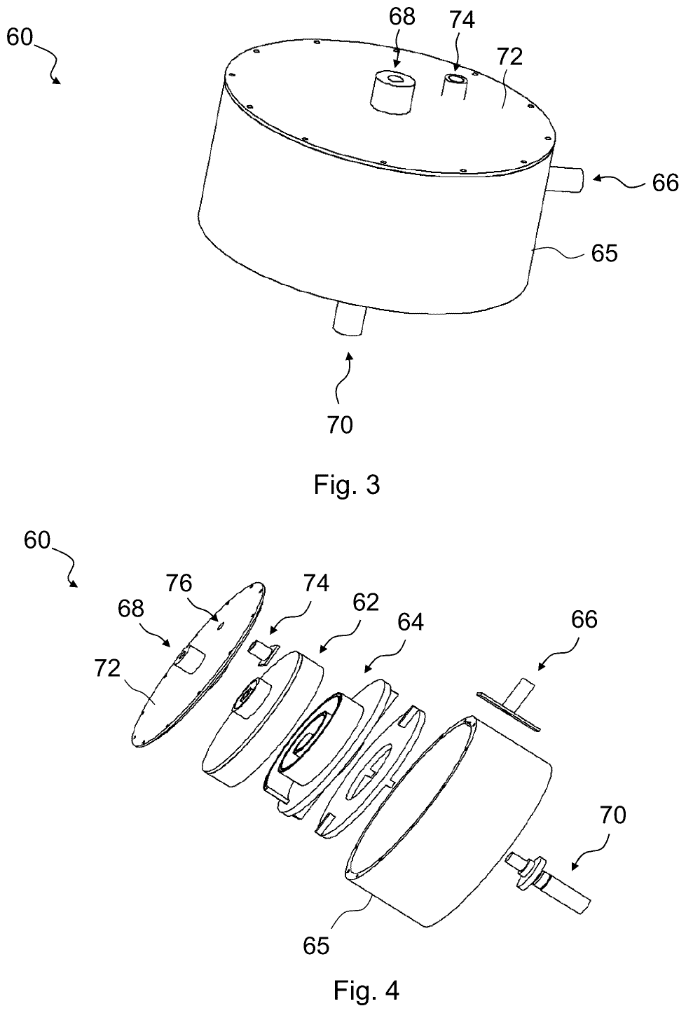

FIG. 3 shows, in a schematic perspective view, a rotary compressor for compressing a refrigerant in a cooling system according to an aspect of the invention;

FIG. 4 shows a schematic exploded view of the rotary compressor shown in FIG. 3;

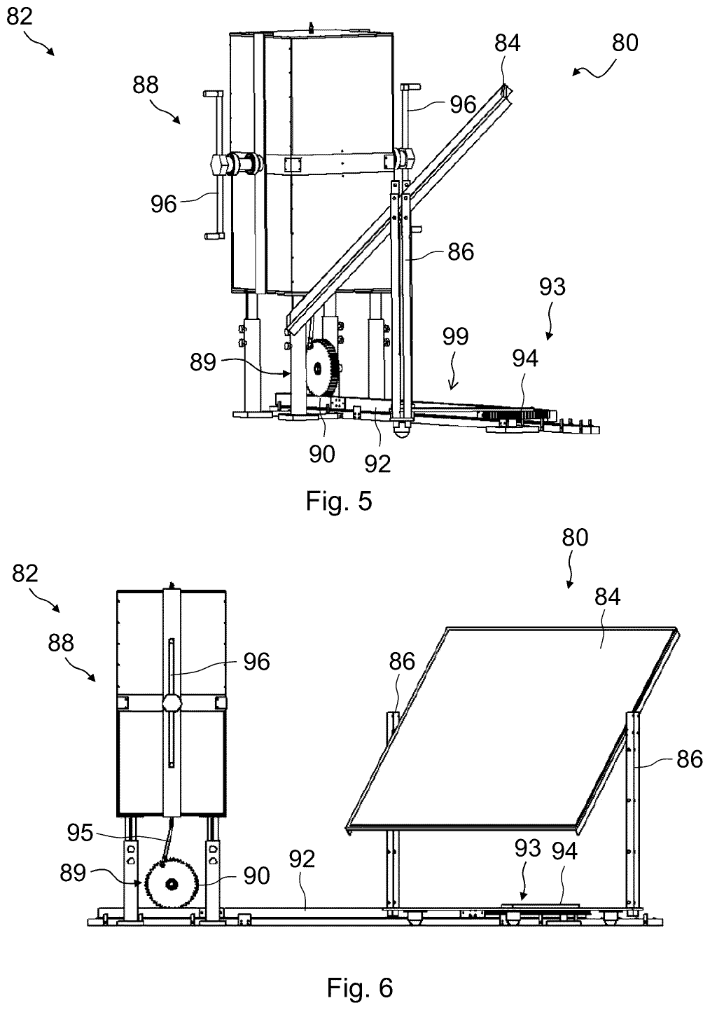

FIG. 5 shows, in a schematic side view, a solar tracking device according to an aspect of the invention;

FIG. 6 shows, in a schematic front view, the solar tracking device of FIG. 5;

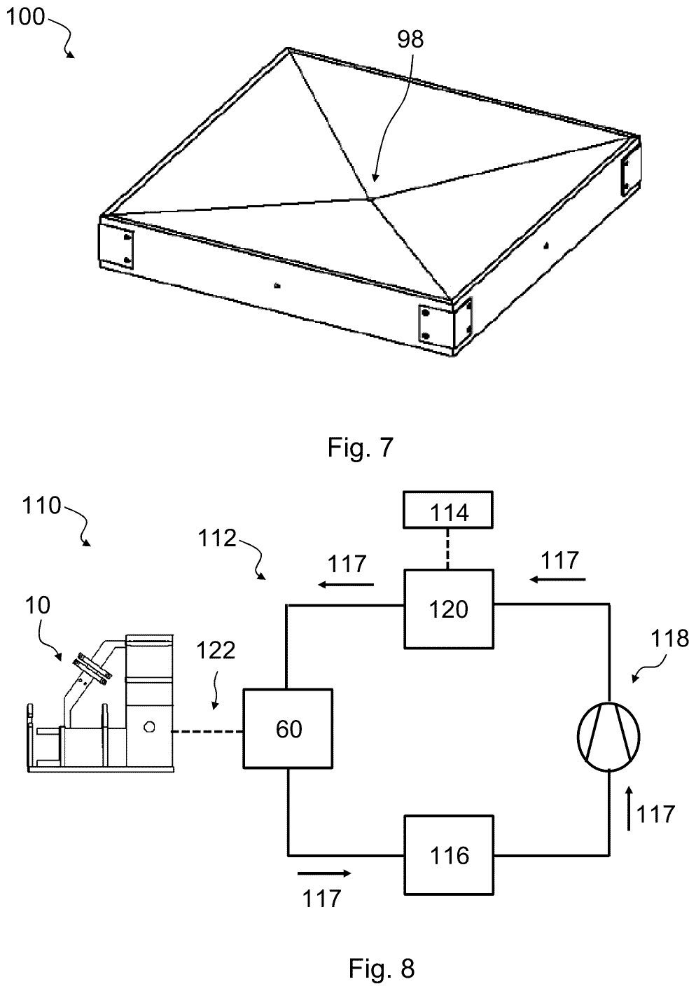

FIG. 7 shows an opening of the solar tracking device through which one or more driving objects for driving the solar tracking device may be guided;

FIG. 8 shows a schematic flow diagram for a cooling system according to an aspect of the invention;

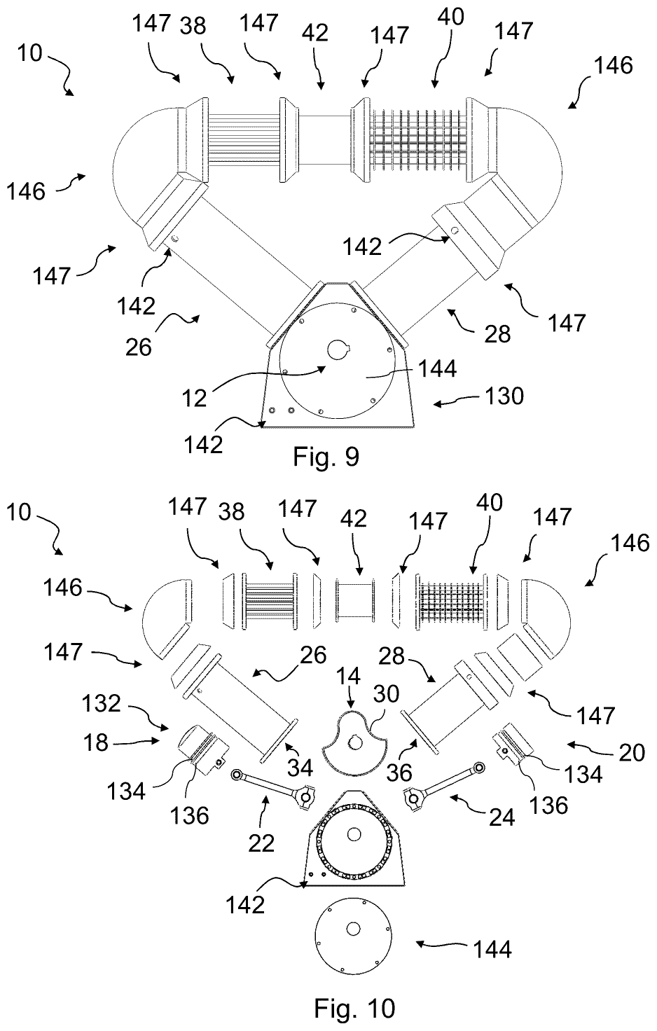

FIG. 9 shows, in a schematic perspective view, a Stirling motor for driving a compressor system according to a further embodiment of the invention;

FIG. 10 shows a schematic exploded view of the Stirling motor shown in FIG. 9;

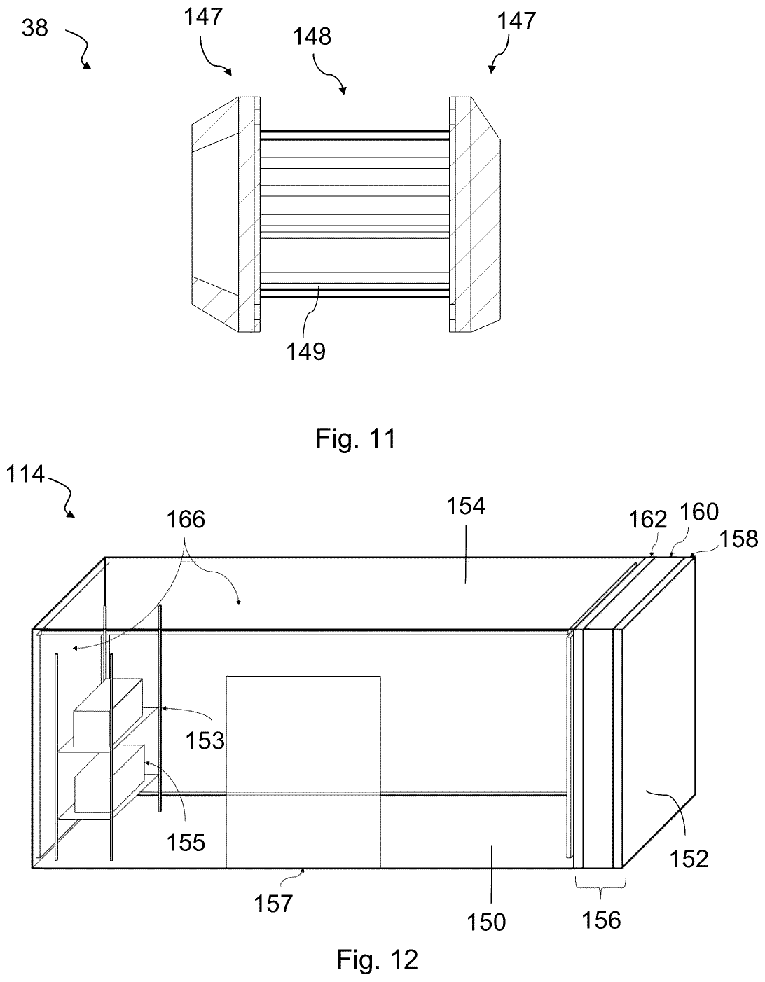

FIG. 11 shows a schematic perspective view of a hot heat exchanger of the Stirling motor shown in any of FIGS. 1, 2, 9, and 10;

FIG. 12 shows a schematic perspective view of the cooling chamber shown in FIG. 8.

### DETAILED DESCRIPTION OF THE EMBODIMENTS

FIGS. 1 and 2 show a Stirling motor 10 for driving a compressor, in particular a rotary compressor, which is shown in FIGS. 3 and 4 and described in greater detail below. The Stirling motor 10 includes a rotatable driveshaft 12 which is operatively connectable to the compressor, e.g., a shaft of the compressor, and configured to rotatably drive the compressor.

An end 14 of the driveshaft 12 is rotatably mounted to a mount structure 16.

The Stirling motor 10 further includes a first piston 18 and a second piston 20 which is operatively coupled with the first piston 18 via the driveshaft 12. The first piston 18 and the second piston 20 are each connected to the driveshaft 12 via a respective connecting rod 22, 24. The first piston 18 and the second piston 20 are slidably arranged in and guided by a first cylinder 26 and a second cylinder 28, respectively. The driveshaft 12 includes one or more counterweights 30, e.g., for balancing the driveshaft 12. The first cylinder 26 and the second cylinder 28 are supported by respective support structures 32.

The first cylinder 26 defines an expansion space 34 in which the first piston 18 is slidably arranged and in which a working medium is arrangeable. The second cylinder 28 defines a compression space 36 in which the second piston 20 is slidably arranged and in which the working medium is compressible. A variety of working media may be used with the Stirling motor 10 described herein. For instance, the working medium may be air, preferably pressurized air, helium, hydrogen or any other compressible/expandable medium.

The Stirling motor 10 may include a hot heat exchanging device 38 for transferring heat from the heat source to the expansion space 34 and a cold heat exchanging device 40 for transferring heat from the compression space 36 to an ambient environment.

The Stirling motor 10 further includes a regenerative heat exchanging device 42 configured to at least temporarily store thermal energy by absorbing thermal energy from the working medium and dissipating the thermal energy back to the working medium in a time-separated manner. The regenerative heat exchanging device 42 is arranged in a refrigerant flow path 44 between the expansion space 34 and the compression space 36 such that the working medium periodically flows from the expansion space 34 to the compression space 36 through the regenerative heat exchanging device 42 to transfer heat from the working medium to the regenerative heat exchanging device 42 and from the compression space 36 to the expansion space 34 back through the regenerative heat exchanging device 42 to transfer heat from the regenerative heat exchanging device 42 to the working medium.

The regenerative heat exchanging device 42 may include at least one porous medium for storing thermal energy. The regenerative heat exchanging device 42 may include a wire mesh structure, preferably made of a plurality of stainless steel wires, for storing thermal energy.

The Stirling motor 10 is configured to cooperate with at least one heat source (not shown) such that the working medium is heatable in the expansion space 34 by the heat source to expand the working medium and drive the first piston 18 to rotatably drive the driveshaft 12 and thus the compressor. The working medium may be heatable by a variety of different heat sources. The heat source preferably includes one or more of the following: solar power, hydrocarbon fuel, heat generated by decaying plants, biomass, water vapor, geothermal energy, brine, nuclear energy, waste heat from external processes, and body heat.

FIGS. 3 and 4 show a compressor 60 for pressurising at least one medium, such as refrigerant. The compressor 60 shown in FIGS. 3 and 4 is configured as a rotary compressor, more specifically as a scroll compressor. However, other types of compressors, in particular rotary compressors, such as a screw-type compressor, a vane-type compressor, a lobe-type (roots-style) compressor or a piston compressor having a rotating crankshaft, may be used. The compressor 60 operates according to the generally known principle of a scroll compressor.

The compressor 60 includes a fixed scroll 62, also referred to as a stator, and a moving scroll 64, also referred to as an orbiting scroll, which moves, or orbits, relative to the fixed scroll 62. The fixed scroll, or stator, 62 and the moving scroll, or orbiting scroll, 64 are arranged in a common housing 65. A compression chamber, in which a pressurizable medium, such as a refrigerant, is received, is defined between the fixed scroll 62 and the moving scroll 64 to pressurize the medium in the compression chamber as the moving scroll 64 moves, or orbits, relative to the fixed scroll 62. The pressurizable medium is drawn into the housing 65 via an inlet 66 and is discharged as a pressurized medium from the housing 65 via an outlet 68. The moving scroll 64, or orbiting scroll, is coupled to a compressor driveshaft 70, wherein the compressor driveshaft 70 is configured to movably drive the moving scroll, or orbiting scroll, 64.

The compressor 60 further includes a closing plate 72 which may be connected to the fixed scroll 62 by one of more connections means, preferably mechanical connection means, such as one or more screws, one or more rivets, etc.

The compressor 60 further includes an introduction element 74 for introducing the pressurizable medium, such as the refrigerant, into the compressor 60 and/or for at least partially expelling the pressurizable medium from the compressor 60. The introduction element 74 may be selectively openable and/or closeable. For instance, the introduction element 74 may be opened to allow introduction of the pressurizable medium into the compressor 60. Once the pressurizable medium has been introduced into the compressor 60, the introduction element 74 may be closed to substantially prevent, or at least limit, the pressurizable medium from being introduced into and/or expelled from the compressor 60. The introduction element 74 74 is inserted through an opening 76 defined in the closing plate 72.

The compressor 60 is configured to be coupled to the Stirling motor 10 shown in FIGS. 1 and 2, e.g., by configuring the compressor driveshaft 70 to be couplable to the driveshaft 12 of the Stirling motor 10. Preferably, the compressor driveshaft 70 is couplable to the driveshaft 12 of the Stirling motor 10 via a flexible coupling, e.g., to allow the rotatable driveshaft 12 of the Stirling motor 10 and the rotatable driveshaft 70 of the compressor 60 to move relative to each other to a certain degree while maintaining a coupled connection therebetween.

FIGS. 5 and 6 show a solar energy capturing device 80 and a solar tracking device 82 configured to move the solar energy capturing device 80 in accordance with the path of the sun to optimize the degree of solar energy which can be captured by a solar energy capturing device 80. The solar energy capturing device 80 includes a solar collector 84 which is configured to capture energy from sun rays, as is known in the art. The solar collector 84 is rotatably mounted to at least one support structure (e.g. two side support structures 86) to allow the solar collector 84 to be rotated relative to the side support structures 86, e.g., to optimize and/or increase the amount of sun rays which may be collected by the solar collector 84. The solar collector 84 may be rotated relative to the side support structures 86 manually, e.g., by exertion of a force by a user, and/or automatically, i.e., without user intervention. The solar connector 84 may include at least one optical device (not shown) including one or more lenses, preferably Fresnel lenses, or one or more mirrors configured to concentrate solar rays.

Preferably, the solar tracking device 82 is driven only mechanically. Preferably, the solar tracking device 82 is driven by potential energy, as described in detail further below. The solar tracking device 82 is configured to align the solar energy capturing device 80, preferably including one or more lenses of the solar energy capturing device 80, to maximize the degree of solar energy which can be captured by the solar energy capturing device 80.

In the embodiment shown in FIGS. 5 and 6, the solar tracking device 82 is configured to rotatably and/or translationally move the solar energy capturing device 80 and/or at least an element thereof, to maximize the degree of solar energy which can be captured by the solar energy capturing device 80. For the purpose of movably driving the solar energy capturing device 80, the solar tracking device 82 includes a drive mechanism 88. The drive mechanism 88 is configured to receive one or more movable driving objects (not shown). Preferably, the driving objects are configured to be rollable or slidable, preferably spherical, preferably metal marbles. Small stones, pebbles or sand could also be used. The drive mechanism 88 is configured to guide the driving objects from a first state of potential energy at a first height, with respect to the direction of gravity, to a second state of potential energy at a second height, with respect to the direction of gravity, wherein the first state of potential energy and the first height are greater than the second state of potential energy and the second height, respectively. Thus, the drive mechanism 88 may be driven to moveably drive the solar tracking device 80 and the solar energy capturing device 82 due to a conversion of the potential energy of the driving objects into a driving energy for the drive mechanism 88. For instance, the weight of the driving objects may provide a driving force to the drive mechanism 88 as the driving objects are guided through the drive mechanism 88 from their first height to their second height as their potential energy is reduced. For instance, the drive mechanism 88 may include a scale-like element or receptacle which is pushed further in the direction of gravity by the weight of the driving objects as the driving objects are accumulated on the scale-like element or receptacle. In particular, the drive mechanism 88 may include two such scale-like elements or receptacles, e.g. two such scale-like elements or receptacles arranged at opposite ends of the drive mechanism 88.

The drive mechanism 88 be considered to function in an hourglass manner, as described below.

For the purpose of driving the drive mechanism 88 to drive the solar energy capturing device 82 into movement, the drive mechanism 88 includes a first force transferring mechanism 89 which includes a first rotary element (such as a first gearwheel 90, or disk) which engages in a counter engaging element, which may be configured as a toothed rack 92, belt or chain, to move the toothed rack relative to the solar tracking device 82. The driving objects may transfer a driving force to the rotary element via a connecting element, e.g. a connecting rod 95. The connecting rod 95 may be driven, e.g., by a scale-like element or receptacle which is pushed further in the direct of gravity by the weight of the driving objects as the driving objects are accumulated on the scale-like element, as described above. The toothed rack 92, in turn, is operatively connected to a second force transferring mechanism 93 which includes a second rotary element (such as a second gearwheel 94 or disk) which is operatively coupled to the energy capturing device 80. The first gearwheel 90 and/or the second gearwheel 94 may each be configured as part of a pinion shaft, respectively.

The connecting rod 95 may be releasably attached to the first gearwheel 90 and/or releasably attached to the receptacle in which the driving objects are accumulated, e.g., by means of one or more magnetic elements, such as one or more magnetic ball joints. This may enable a user to disengage the connecting rod 95 from the first gearwheel 90 and/or from the receptacle on demand, e.g., for resetting the drive mechanism 88, as described further below. For example, when the drive mechanism 88 is to be reset, the connecting rod 95 could be disconnected from the (first) receptacle in which the driving objects have been accumulated. Thereafter, the drive mechanism 88 could be rotated so that the (second) receptacle arranged at the opposite side of the drive mechanism 88 is located proximate the connecting rod 95. Then, the connecting rod 95 could be connected to the (second) receptacle.

The energy capturing device may be eccentrically connected to the second gearwheel 94, e.g., via a rod 99.

Thus, due to the transfer of drive forces from the drive mechanism 88 to the energy capturing device 80 via the first force transferring mechanism 89 and the second force transferring mechanism 93, the energy capturing device 80, more specifically the solar collector 84, and optionally further components of the energy capturing device 80, such as one or more optical elements, e.g., lenses, may be rotationally and/or translationally moved to substantially follow the sun's path. The path of movement of the energy capturing device 80 may be predetermined. As described above, the solar tracking device 82 is driven purely mechanically.

Once a majority of or all driving objects have reached their respective lowest point, i.e., in the second state of potential energy, the drive mechanism 88 may be reset, e.g., manually and/or automatically, such that the driving objects are repositioned to their respective first positions. In the embodiment shown in FIGS. 5 and 6, the drive mechanism 88 is rotatable by means of a gripping handle 96, e.g., which may gripped by a user to rotate the drive mechanism 88, preferably substantially by 180°. Thus, when the user wishes to reset the drive mechanism 88, e.g., due to a power reserve of the drive mechanism 88 reaching zero, the user may disconnect the connecting rod 95 from the first gearwheel 90 and/or from the receptacle, which may enable the user to reset the drive mechanism 88 by rotating the drive mechanism 88 via the handle 96. Thereafter, the connecting rod 95 may be reconnected to the first gearwheel 90 and/or to the other receptacle. This may provide a simple and quick means for resetting the drive mechanism 88. Preferably, the drive mechanism 88 has a power reserved of at least 10 hours, preferably at least 12 hours, more preferably at least 14 hours, more preferably at least 16 hours, more preferably at least 18 hours.

FIG. 7 shows an opening 98 defined in a plate element 100, wherein the driving objects are guided through the opening 98 as they move from their respective first positions to their respective second positions. Preferably, the opening 98 has the smallest cross-section in a path of the driving objects through the solar tracking device in order to determine the flow rate of the driving objects through the drive mechanism 88 by one or more properties of the opening 98, such as the shape and/or dimensions thereof. The driving objects may have a fixed flow rate or a variable flow rate through the drive mechanism 88. The opening 98 may have a fixed cross-section. Alternatively, the cross-section of the opening 98 may be variable and/or adjustable, e.g., to vary the flow rate of the driving objects therethrough. The cross-section of the opening 98 may be manually, i.e., by a user input, or automatically, i.e., without user intervention, variable and/or adjustable.

FIG. 8 shows a cooling system 110 having a refrigeration arrangement 112. The refrigeration arrangement 112 includes at least one cooling chamber 114 configured to receive one or more objects to be cooled. The refrigeration arrangement 112 further includes the compressor 60 shown in FIGS. 3 and 4 and a condenser 116 which is arranged downstream from the compressor 60, with respect to a direction of flow 117 of the refrigerant, and configured to receive the pressurised refrigerant. The condenser 116 is configured to dissipate heat from the refrigerant to an ambient which is arranged at least partially outside of the cooling chamber 114. The refrigeration arrangement 112 also includes an expander 118 arranged downstream from the condenser 116 and configured to expand the refrigerant. The refrigeration arrangement 112 further includes an evaporator 120 which is arranged downstream from the expander 118 and operatively connected to the cooling chamber 114, which is indicated in FIG. 8 by a dashed line, to absorb heat from the cooling chamber 114 to the refrigerant. The evaporator 120 may be directly and/or indirectly connected to the cooling chamber 114 to absorb heat from the cooling chamber 114 to the refrigerant. For instance, the evaporator 120 may be at least partially in contact with at least a section of the cooling chamber 114 to absorb heat from the cooling chamber 114 to the refrigerant. Alternatively, or additionally, the evaporator 120 may be at least partially in contact with an intermediate structure, e.g., at least one phase change material (PCM), which is operatively connected to the cooling chamber 114 such that the evaporator 120 may absorb heat from the cooling chamber 114 to the refrigerant via the intermediate structure, e.g., the PCM.

The compressor 60 is rotatably driven by the Stirling motor 10 shown in FIGS. 1 and 2 via a coupling 122, preferably flexible coupling, which is indicated in FIG. 8 by a dashed line, between the driveshaft 12 of the Stirling motor 10 and the compressor driveshaft 70.

FIG. 9 shows a Stirling motor 10 according to a further variation which is similar to the Stirling motor shown in FIGS. 1 and 2. The Stirling motor 10 includes a crankcase 130 through which the driveshaft 12 passes. It will be appreciated that this motor 10 may be combined with the other parts of the system described above, e.g. with the compressor 60 and/or the solar energy capturing device 80.

FIG. 10 schematically shows an exploded view of the Stirling motor 10 of FIG. 9. In particular, FIG. 10 shows more details of the first piston 18. The first piston 18 may be provided with a crown 132 configured to at least partially shield or protect one or more seals of the first piston 18, e.g., from heat, in particular excessive heat. For instance, the first piston 18 may be provided with one or more first grooves 134 configured to at least partially receive one or more first sealing elements, e.g., at least one composite sealing ring. The first piston 18 may be provided with one or more second grooves 136 configured to at least partially receive one or more second sealing elements, e.g., at least one guide ring. Alternatively, or additionally, the second piston 20 may also include one or more first grooves 134 configured to at least partially receive one or more first sealing elements and/or one or more second grooves 136 configured to at least partially receive one or more second sealing elements, e.g., at least one guide ring.

The driveshaft 12 may include one or more counterweights 30, e.g., for balancing the driveshaft 12. The first cylinder 26 and the second cylinder 28 may be supported by the crankcase 130. A crankcase volume arranged with the crankcase 130 may be pressurized and the crankcase 130 may be closed by a sealed cap 144.

The first cylinder 26, the second cylinder 28 and the crankcase 130 may be provided with one or more fittings 142 for connecting one or more sensors, e.g., one or more pressure sensors, one or more temperature sensors and/or one or more flow sensors.

According to the configuration shown in FIGS. 9 and 10, at least two manifolds 146 may connect the hot heat exchanging device 38 to the first cylinder 26 and the cold heat exchanging device 40 to the second cylinder 28. Connecting elements 147 ensure mechanical connection between devices that have different diameters, i.e., the manifolds 146, the hot heat exchanging device 38, the cold heat exchanging device 40, the regenerative heat exchanging device 42, the first cylinder 26 and the second cylinder 28.

FIG. 11 shows the hot heat exchanging device 38 of the Stirling motor in greater detail. The hot heat exchanging device 38 preferably includes a double glazing 148 with a thickness ranging from 2 to 5 mm. A vacuum may be provided within the double glazing 148, e.g., in a space provided between two glass cylinders, e.g., with a pressure of less than 1 mBar. A material 149 may be arranged inside the double glazing 148 in which the tubes of the hot heat exchanging device 38 may be immersed. The material 149 may be configured to store heat.

FIG. 12 shows the cooling chamber 114 of FIG. 8 in greater detail. In particular, the cooling chamber 114 may be delimited by one or more delimiting structures, e.g., at least one floor 150, one or more walls 152 and at least one roof 154. The cooling chamber 114 may also include at least one door 157. The cooling chamber 114 may include one or more shelves 153 on which one or more objects 155 to be cooled can be stored.

One or more of the delimiting structures 156 may include one or more layers. Preferably, one or more of the delimiting structures may have a tri-layer structure which includes an outer cladding 158, an insulation layer 160 and an inner recovering 162.

The cooling chamber 114 may include at least one thermal energy storage system 166 made of at least one plate filled at least partially with at least one phase change material. The thermal energy storage system 166 may be traversed by at least one evaporator, e.g., the evaporator 120 shown in FIG. 8

The cooling chamber 114 may be configured to be non-electrically powered.

1-47. (canceled)

48. A cooling system, including:
a refrigeration arrangement, including:
at least one cooling chamber configured to receive one or more objects to be cooled;
at least one rotary compressor for pressurising at least one refrigerant;
at least one condenser which is arranged downstream from the rotary compressor, with respect to a direction of flow of the refrigerant, and configured to receive the pressurised refrigerant, wherein the condenser is configured to dissipate heat from the refrigerant to an ambient which is arranged at least partially outside of the cooling chamber;
at least one expander arranged downstream from the condenser and configured to expand the refrigerant; and
at least one evaporator which is arranged downstream from the expander and operatively connected to the cooling chamber to absorb heat from the cooling chamber to the refrigerant;
at least one Stirling motor having at least one rotatable driveshaft which is operatively connected to the rotary compressor and configured to rotatably drive the rotary compressor;
at least one solar energy capturing device which is configured to capture solar energy; and
at least one solar tracking device configured to maximize the degree of solar energy which can be captured by the solar energy capturing device, wherein the solar tracking device is driven only mechanically;
wherein the Stirling motor includes at least one expansion space, in which at least one working medium is arrangeable and expandable, a first piston which is movably arranged at least partially in the expansion space, at least one compression space, in which the working medium is arrangeable and compressible by a second piston which is operatively coupled with the first piston via the driveshaft and movably arranged at least partially in the compression space, wherein the Stirling motor is configured to cooperate with at least one heat source such that the working medium is heatable in the expansion space by the heat source to expand the working medium and drive the first piston to rotatably drive the driveshaft.

49. The cooling system according to claim 48, wherein the Stirling motor is configured to cooperate with the solar energy capturing device such that the solar energy capturing device can provide thermal energy to the expansion space based on the captured solar energy to heat the working medium.

50. The cooling system according to claim 48, further including at least one phase change element which is at least partially made of a phase change material (PCM), wherein the phase change element is arranged at least partially around the cooling chamber, wherein the phase change element is configured to absorb and store thermal energy from the refrigerant and release the thermal energy on demand to cool the cooling chamber.

51. The cooling system according to claim 48, wherein the Stirling motor is configured such that the working medium is heatable by one or more of the following heat sources: hydrocarbon fuel, heat generated by decaying plants, biomass, water vapor, geothermal energy, brine, nuclear energy, waste heat from external processes, and body heat.

52. The cooling system according to claim 48, wherein the Stirling motor includes a hot heat exchanging device.

53. The cooling system according to claim 48, wherein the solar tracking device is configured to follow the path of the sun to maximize the degree of solar energy which can be captured by the solar energy capturing device.

54. The cooling system according to claim 48, wherein the solar tracking device is driven only by potential energy.

55. The cooling system according to claim 48, wherein the solar tracking device is configured to receive at least one solar energy capturing device, wherein the solar tracking device is configured to align the solar energy capturing device to maximize the degree of solar energy which can be captured by the solar energy capturing device.

56. The cooling system according to claim 48, wherein the solar tracking device is configured to receive one or more movable driving objects, wherein the solar tracking device is configured to guide the driving objects from a first state of potential energy at a first height, with respect to the direction of gravity, to a second state of potential energy at a second height, with respect to the direction of gravity, wherein the first state of potential energy and the first height are greater than the second state of potential energy and the second height, respectively, such that the driving objects drive the solar energy capturing device into movement as the driving objects are guided from the first state of potential energy at the first height to the second state of potential energy at the second height to follow the path of the sun.

57. The cooling system according to claim 56, wherein the solar tracking device includes at least one opening through which the driving objects are moveable at a moving speed.

58. The cooling system according to claim 52, wherein the hot heat exchanging device includes a thermal energy storage system which includes at least one container filled with a thermal storage material to store heat.

59. The cooling system according to claim 58, wherein the thermal storage material is configured to store heat provided to the Stirling motor by the solar energy capturing device.

60. The cooling system according to claim 56, wherein the solar energy capturing device includes an optical device including one or more lenses configured to concentrate solar rays.

61. The cooling system according to claim 60, wherein the one or more lenses include one or more Fresnel lenses.

62. The cooling system according to claim 60, wherein the solar tracking device is configured to align the one or more lenses of the solar energy capturing device to maximize the degree of solar energy which can be captured by the solar energy capturing device.

63. The cooling system according to claim 56, wherein the one or more movable driving objects are rollable or slidable driving objects or ball-like driving objects.

64. The cooling system according to claim 56, wherein the one or more movable driving objects are metal marbles.

65. The cooling system according to claim 57, wherein the moving speed is variable.

66. The cooling system according to claim 57, wherein the moving speed is variable by varying one or more properties of the opening.

67. The cooling system according to claim 57, wherein the moving speed is variable by varying at least a cross-section of the opening.
